(19) United States
(12) Patent Application Publication
(10) Pub. No.: US 2026/0230532 A1
(43) Pub. Date: Aug. 6, 2026

(54) First Node, Second Node, Third Node, Fourth Node, and Methods Performed Thereby for Handling Information Indicating One or More Policies

(71) Applicant: Telefonaktiebolaget LM Ericsson (publ), Stockholm (SE)

(72) Inventors: Emiliano Merino Vazquez, Madrid (ES); Rodrigo Alvarez Dominguez, Madrid (ES); Miguel Angel Muñoz De La Torre Alonso, Madrid (ES)

(21) Appl. No.: 19/148,824

(22) PCT Filed: Jan. 30, 2023
(86) PCT No.: PCT/EP2023/052178

§ 371 Date: Jul. 17, 2025

(30) Foreign Application Priority Data
Jan. 17, 2023 (EP) 23382035.6

(51) Int. Cl. H04L 67/51

(52) U.S. Cl. CPC H04L 67/51

(57) ABSTRACT

A computer-implemented method, performed by a first node (111). The method is for handling information indicating one or more policies. The first node (111) operates in a communications system (100). The first node (111) obtains (301), directly or indirectly, a first indication from a second node (112). The second node (112) hosts one or more first applications managing delivery of content to a user equipment (130) operating in the communications system (100). The first indication indicates a request to provide information indicating one or more policies applicable to the content to be delivered to a user of the user equipment (130). The first node (111) also initiates (304), responsive to the obtained first indication, providing another indication to the second node (112). The another indication indicates the information.

### TECHNICAL FIELD

The present disclosure relates generally to a first node and methods performed thereby for handling information indicating one or more policies. The present disclosure also relates generally to a second node, and methods performed thereby for handling the information indicating one or more policies. The present disclosure further relates generally to a third node, and methods performed thereby for handling the information indicating one or more policies. The present disclosure additionally relates generally to a device, and methods performed thereby for handling the information indicating one or more policies.

### BACKGROUND

Computer systems in a communications network or communications system may comprise one or more nodes. A node may comprise a processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. The AF 1 may allow external parties to use the Exposure Application Program Interfaces (APIs) offered by the Mobile Network Operator (MNO). In case the AF may be trusted, e.g., internal to the network operator, the AF may interact with the 3GPP Core Network directly, with no NEF involved. The NEF 2 may support different functionality, e.g., may support different Exposure APIs, e.g., sponsored Data, Quality of Service (QOS), etc., which may allow a content provider to request policies from the MNO. The NEF 2 may be understood to act as the entry point into the network of the operator, so an external AF, e.g., a content provider, may interact with the 3GPP Core Network through the NEF 2.

A Unified Data Repository (UDR) 3 may store data grouped into distinct collections of subscription-related information: subscription data, policy data, structured data for exposure, and application data. The Charging Function (CHF) 4 may support charging related functionality, specifically online and offline charging. The Policy Control Function (PCF) 5 may support a unified policy framework to govern the network behavior. Specifically, the PCF 5 may provide Policy and Charging Control (PCC) rules to the Policy and Charging Enforcement Function (PCEF), that is, the Session Management Function (SMF) 6/User Plane function (UPF) 7 that may enforce policy and charging decisions according to provisioned Policy and Charging Control (PCC) rules. The SMF 6 may support different functionalities, e.g., may receive PCC rules from the PCF 5 and may configure the UPF 7 accordingly. The UPF 7 may support handling of user plane traffic based on the rules received from the SMF 6, e.g., packet inspection and different enforcement actions such as reporting for charging and QoS handling. The PCF 5 may provide policy rules to a UE through the Access and Mobility Function (AMF) 8. The AMF 8 may manage access of the UE. For example, when the UE may be connected through different access networks, and mobility aspects of the UE. Also depicted in FIG. 1 is a Network Data Analytics Function (NWDAF) 9. Each of the UDR 3, the NEF 2, the NWDAF 9, the AF 1, the PCF 5, the CHF 4, the AMF 8, the SMF 6 and the UPF 7 may have an interface through which they may be accessed, which as depicted in the Figure, may be, respectively: Nudr 10, Nnef 11, Nnwdaf 12, Naf 13, Npcf 14, Nchf 15, Namf 16, Nsmf 17 and N4 18.

### 3GPP Exposure Framework

3GPP has defined a framework for Exposure. Specifically, there may be a northbound interface between the content provider, e.g., the AF, and the network operator, e.g., the NEF, supporting a set of APIs, e.g., QOS, Sponsored Data, etc.

Under existing methods, however, content may be delivered towards users in an incorrect manner.

### SUMMARY

As part of the development of embodiments herein, one or more challenges with the existing technology will first be identified and discussed.

A user in a communications system may have different types of subscriptions to a content provider and to an MNO. For example, a user may have a first type of subscription with the content provider a second, more basic, type of subscription with the MNO.

The above implies that the policies to be applied to application traffic of the content provider are uncoordinated at both entities, that is, the content provider and the MNO. This is by far the most common scenario today, namely, when there is no Service Level Agreement (SLA) between the content provider and the MNO.

As an example, if the user is has a first type of subscription with the content provider for delivery of high speed data, e.g., 100 Mbps, for traffic of a certain application, and if the user has a second, more basic, type of subscription, e.g., 50 Kbps, with the MNO, the traffic of the application may be handled by the MNO with standard, lower, quality, so the resulting E2E streaming quality will be worse than what the user may be entitled to received, not allowing the users to optimize their subscriptions, as the user is most probably not aware of this inconsistency.

In addition, when a content provider may request the MNO, e.g., through the NEF, to apply a certain policy, e.g., QoS, to the traffic of the application content provider, the content provider is not aware of which may be the MNO policies allowed in correspondence to the subscription of the user with the MNO. It may be noted that the MNO policies may be understood to usually be locally and statically configured, e.g., at the UDR as, for example, Gold, Silver or Bronze subscriber, but they may also be dynamic, e.g., they may be subject to Time of Day (ToD) policies, congestion situations, etc.

There is currently no mechanism for the end user to retrieve the MNO policies, e.g., QoS.

According to the foregoing, it is an object of embodiments herein to improve the handling of information indicating one or more policies in a communications system.

According to a first aspect of embodiments herein, the object is achieved by a computer-implemented method, performed by a first node. The method is for handling information indicating one or more policies. The first node operates in the communications system. The first node obtains, directly or indirectly, a first indication from a second node. The second node hosts one or more first applications managing delivery of content to a user equipment operating in the communications system. The first indication indicates a request to provide information indicating one or more policies applicable to the content to be delivered to a user of the user equipment. The first node then initiates, responsive to the obtained first indication, providing another indication to the second node. The another indication indicates the information.

According to a second aspect of embodiments herein, the object is achieved by a computer-implemented method, performed by the second node. The method is for handling the information indicating the one or more policies. The second node hosts one or more first applications managing the delivery of the content to the user equipment operating in the communications system. The second node sends, directly or indirectly, the first indication to the first node operating in the communications system. The first indication indicates the request to provide information indicating the one or more policies applicable to the content to be delivered to the user of the user equipment. The second node also receives, responsive to the sent first indication, the another indication from the first node. The another indication indicates the information.

According to a third aspect of embodiments herein, the object is achieved by a computer-implemented method, performed by the third node. The method is for handling the information indicating the one or more policies. The third node operates in the communications system. The third node receives a second indication from the first node operating in the communications system. The second indication requests the one or more policies applicable to the content to be delivered to the user of the user equipment operating in the communications system. The third node then sends a third indication to the first node in response to the received second indication. The third indication indicates the requested one or more policies.

According to a fourth aspect of embodiments herein, the object is achieved by a computer-implemented method, performed by the fourth node. The method is for handling the information indicating the one or more policies. The fourth node operates in the communications system and hosts one or more second applications. The fourth node acts on behalf of the user equipment operating in the communications system. The fourth node obtains the first indication from the second node. The second node hosts the one or more first applications managing the delivery of the content to the user equipment. The first indication indicates the request to provide the information indicating the one or more policies applicable to the content to be delivered to the user of the user equipment. The fourth node also initiates, responsive to the obtained first indication, forwarding the first indication to the first node operating in the communications network, thereby initiating providing the another indication to the second node. The another indication indicates the information.

According to a fifth aspect of embodiments herein, the object is achieved by the first node, for handling the information configured to indicate the one or more policies. The first node is configured to operate in the communications system. The first node is further configured to obtain, directly or indirectly, the first indication from the second node. The second node is configured to host the one or more first applications configured to manage the delivery of the content to the user equipment configured to operate in the communications system. The first indication is configured to indicate the request to provide the information configured to indicate the one or more policies configured to be applicable to the content configured to be delivered to the user of the user equipment. The first node is also configured to initiate, responsive to the first indication configured to be obtained, providing the another indication to the second node. The another indication is configured to indicate the information.

According to a sixth aspect of embodiments herein, the object is achieved by the second node, for handling the information configured to indicate the one or more policies. The second node is configured to host the one or more first applications configured to manage the delivery of the content to the user equipment configured to operate in the communications system operate. The second node is further configured to send, directly or indirectly, the first indication to the first node configured to operate in the communications system. The first indication is configured to indicate the request to provide the information configured to indicate the one or more policies configured to be applicable to the content to be delivered to the user of the user equipment. The second node is also configured to receive, responsive to the first indication configured to be sent, the another indication from the first node. The another indication is configured to indicate the information.

According to a seventh aspect of embodiments herein, the object is achieved by the third node, for handling the information configured to indicate the one or more policies. The third node is configured to operate in the communications system. The third node is further configured to receive the second indication from the first node configured to operate in the communications system. The second indication is configured to request the one or more policies configured to be applicable to the content to be delivered to the user of the user equipment configured to operate in the communications system. The third node is also configured to send the third indication to the first node in response to the second indication configured to be received. The third indication is configured to indicate the one or more policies configured to be requested.

According to an eighth aspect of embodiments herein, the object is achieved by the fourth node, for handling the information configured to indicate the one or more policies. The fourth node is configured to operate in the communications system and host the one or more second applications. The fourth node is further configured to obtain the first indication from the second node. The second node is configured to host the one or more first applications configured to manage the delivery of the content to the user equipment. The first indication is configured to indicate the request to provide information configured to indicate the one or more policies configured to be applicable to the content to be delivered to the user of the user equipment. The fourth node is also configured to initiate, responsive to the first indication configured to be obtained, forwarding the first indication to the first node configured to operate in the communications network, thereby initiating providing the another indication to the second node. The another indication is configured to indicate the information.

By the second node sending, and the first node obtaining, the first indication, the first node may enable an operator of the communications system to expose the one or more policies that may be allowed for the user equipment, through the first node, e.g., on a per subscriber basis and/or on a per application basis. The one or more policies may be exposed to the second node, e.g., a provider of content or the user of the user equipment. This may in turn enable the second node, e.g., the AF of a provider of content to request from an MNO, e.g., via a NEF of the communications system, the information indicating the one or more policies applicable to the content to be delivered to the user of the user equipment. This may further enable the second node, e.g., the content provider, to choose which may be the most appropriate policy, both on a per subscriber basis, e.g., based on UE-ID, and/or on a per application basis, e.g., based on App-ID. In embodiments wherein the second node may be the user equipment, the end user of the second node may be enabled to request, e.g., through a third party (3PP) application, the MNO policies for certain application/s, e.g., indicated by a list of App-ID, and to choose which may be the most appropriate policy, both on a per subscriber basis and/or on a per application basis. The request may be conveyed at an application level between the application client and the AS.

By initiating providing, and the second node then receiving the another indication, the first node may forward the available MNO policies for the identified user of the user equipment, e.g., UE-ID, and applications, e.g., App-ID/s, to the second node. This may then enable the end user of the user equipment to select the most appropriate policy, e.g., on a per App-ID basis, and indicate it towards the fifth node, e.g., the AF/AS of the provider of content, e.g., at application level. Based on this, the fifth node, or the second node as AF/AS of the content provider, may then be enabled to request the selected policy.

By receiving the second indication from the first node, the third node may then be enabled to send the third indication to the first node indicating the one or more policies that the second node may have originally requested. The third node may then enable the first node to provide the requested one or more policies to the second node, which may be understood to be a node that may not have otherwise direct access to this information by being either external to the communications system, e.g., in the event of being a content provider, or a user device operating in the communications system.

By obtaining the first indication from the second node, and then forwarding it to the first node, the fourth node, which hosts the one or more second applications, may enable, as an intermediary to provide the requested one or more policies to the second node. The second node may be understood to be a node that may otherwise not have direct access to this information by being either external to the communications system, e.g., in the event of being a content provider, or a user device operating in the communications system.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture as defined by 3GPP, according to existing methods.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a flowchart depicting embodiments of a method in a third node, according to embodiments herein.

FIG. 6 is a flowchart depicting embodiments of a method in a fourth node, according to embodiments herein.

FIG. 7 is a schematic diagram depicting a non-limiting example of signalling between nodes in a communications system, according to embodiments herein, for a first use case, wherein MNO policies may be exposed to a Content provider through the NEF.

FIG. 8 is a schematic diagram depicting signalling between nodes in a communications system, according to embodiments herein, for a first non-limiting example of a second use case, wherein MNO policies may be exposed to an end user through the NEF.

FIG. 9 is a schematic diagram depicting signalling between nodes in a communications system, according to embodiments herein, for a second non-limiting example of the second use case, wherein MNO policies may be exposed to an end user through a Business Support System (BSS).

FIG. 10 is a schematic block diagram illustrating two non-limiting examples, a) and b), of a first node, according to embodiments herein.

FIG. 11 is a schematic block diagram illustrating two non-limiting examples, a) and b), of a second node, according to embodiments herein.

FIG. 12 is a schematic block diagram illustrating two non-limiting examples, a) and b), of a third node, according to embodiments herein.

FIG. 13 is a schematic block diagram illustrating two non-limiting examples, a) and b), of a fourth node, according to embodiments herein.

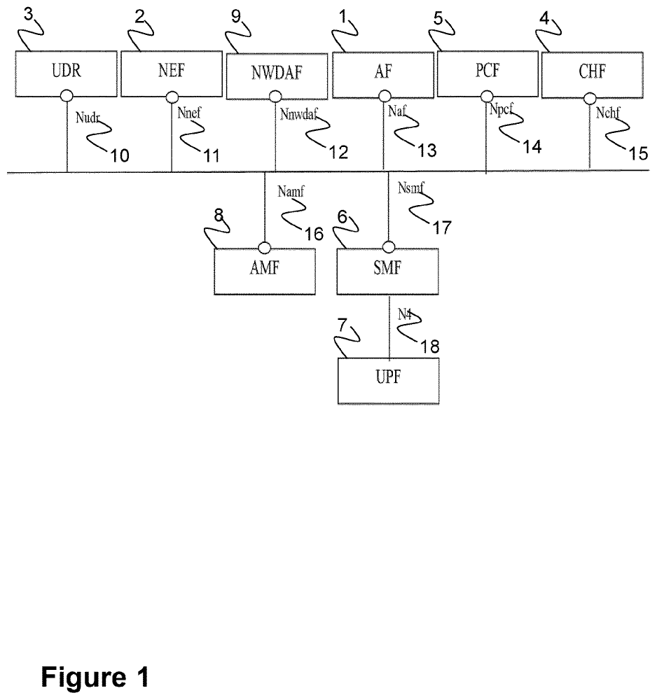

### DETAILED DESCRIPTION

Certain aspects of the present disclosure and their embodiments address one or more of the challenges identified with the existing methods and provide solutions to the challenges discussed.

Embodiments herein may relate to a mechanism to harmonize subscriptions of service provided by an MNO and a of content provider. Embodiments herein may be understood to provide a mechanism which may be understood to address the problems described in the Summary section by providing an approach whereby an MNO exposing the policies which may be allowed for a device through a NEF. This may be performed both, on a per subscriber/session basis, and/or on a per application basis.

The proposed mechanism may be understood to allow the content provider and/or an end user to select the most appropriate policy to be applied.

As an example, the MNO may offer two combinations of policies for the traffic of a certain application, e.g., App-ID=example. com. A first policy combination may be a first type of subscription and a first level of QoS, for example, high speed data, e.g., 100 Mbps. A second policy combination may a second type of subscription and a second level of QoS, for example, lower speed data, e.g., 50 Kbps. According to the mechanism provided by embodiments herein, the end user may then be enabled to choose which policy combination to apply.

The content provider may also choose which policy combination to apply, e.g., if the user has the first type of subscription, e.g., high speed data, e.g., 100 Mbps with the content provider, the content provider may request the MNO to apply the first type of policy combination for that user and application, as identified for example by an App-ID.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

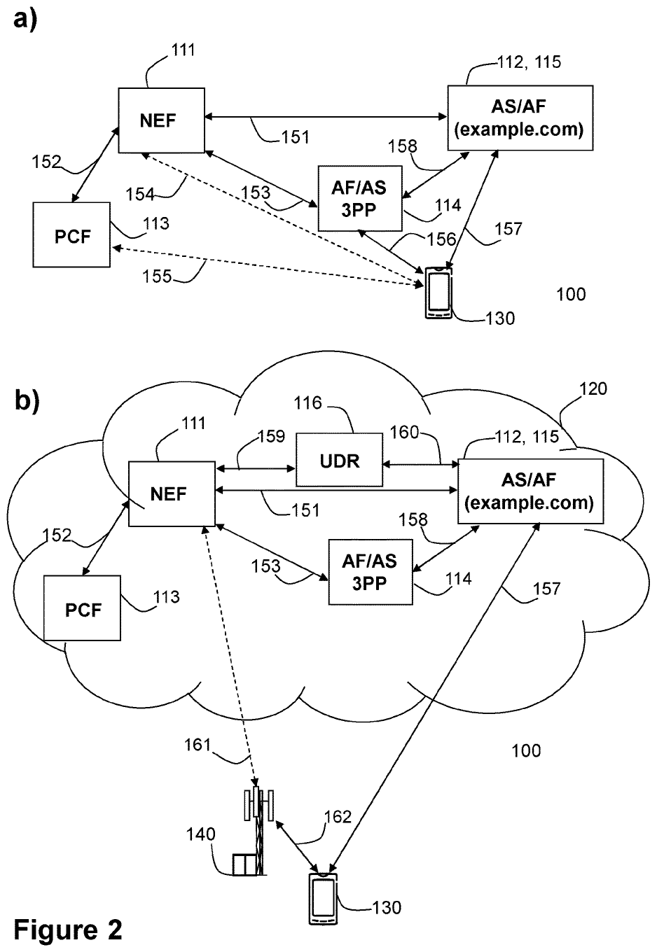

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices. The communications system 100 may for example be a network such as a 5G system, or a newer system supporting similar functionality, or a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band. The telecommunications system may further support other technologies, such as for example Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IOT).

The communications system 100 may comprise a plurality of nodes, and/or operate in communication with other nodes, whereof a first node 111, a second node 112, a third node 113, a fourth node 114 and a fifth node 115 are depicted in both panels of FIG. 2. The communications system 100 may comprise, in some examples, a sixth node 116, depicted in panel b) of FIG. 2. It may be understood that the communications system 100 may comprise more nodes than those represented on FIG. 2. The first node 111, the third node 113, the fourth node 114, the fifth node 115 and the sixth node 116 are comprised in the communications system 100. The second node 112 may be any of comprised in the communications system 100 and/or operate via the communications system 100, e.g., it may be external to the communications system 100.

Any of the first node 111, the second node 112, the third node 113, the fourth node 114, the fifth node 115 and the sixth node 116 may be understood, respectively, as a first computer system, a second computer system, a third computer system, a fourth computer system, a fifth computer system and a sixth computer system. In some examples, any of the first node 111, the second node 112, the third node 113, the fourth node 114, the fifth node 115 and the sixth node 116 may be implemented as a standalone server in e.g., a host computer in the cloud 120, as depicted in the non-limiting example depicted in panel b) of FIG. 2. Any of the first node 111, the second node 112, the third node 113, the fourth node 114, the fifth node 115 and the sixth node 116 may in some examples be a distributed node or distributed server, with some of their respective functions being implemented locally, e.g., by a client manager, and some of their functions implemented in the cloud 120, by e.g., a server manager. Yet in other examples, any of the first node 111, the second node 112, the third node 113, the fourth node 114, the fifth node 115 and the sixth node 116 may also be implemented as processing resources in a server farm.

Any of the first node 111, the third node 113 and the sixth node 116 may be co-localized. Any of the second node 112, the fourth node 114 and the fifth node 115 may be co-localized. Particularly, in some embodiments, the second node 112 may be the same node as the fifth node 115.

The first node 111 may be a node that may have a capability to handle requests for policies from a Mobile Network Operator (MNO). In some embodiments, the first node 111 may be a node that may have a capability to manage exposure to different events, e.g., different Exposure APIs. The first node 111 may optionally support other functionalities, such as handling e.g., sponsored Data, Quality of Service (QOS), etc., which may allow a content provider to request policies from the MNO. The first node 111 may be understood to act as the entry point into the communications system 100, so the second node 112, e.g., a content provider, may interact with the a core network of the communications system 100 through the first node 111. As depicted in FIG. 2, in some embodiments, as in the non-limiting example of FIG. 2, the first node 111 may be a NEF. In other embodiments, the first node 111 may be a node that may have a capability to cater to processes of product management, order management, customer services provisioning, revenue management, and customer management. In examples of such embodiments, the first node 111 may be a BSS.

The second node 112 may be a node having a capability to host one or more applications managing delivery of content to a user equipment (UE) operating in the communications system 100, such as the UE 130 described below. The second node 112 may interact with the core network of the communications system 100 through the first node 111. The second node 112 may allow external parties to use the APIs offered by the communications system 100. As depicted in FIG. 2, in some particular examples, the second node 112 may be an AF or an Application Server (AS) of a content provider. In other examples, the second node 112 may be an AF or an AS, e.g., in a 5G network. Yet in other examples, the second node 112 may be a user equipment, such as the UE 130 described below.

The third node 113 may be a node having a capability to support a unified policy framework to govern the behavior of the communications system 100. Specifically, the third node 113 may provide PCC rules to one or more other nodes in the communication system 100, which may then be applied to traffic. As depicted in FIG. 2, in some examples, the third node 113 may be a PCF.

The fourth node 114 may be a node operating in the communications system 100 and having a capability to host one or more applications managing delivery of content to a user equipment operating in the communications system 100, such as the UE 130 described below. The fourth node 114 may interact with the core network of the communications system 100 through the first node 111. The fourth node 114 may allow external parties to use the APIs offered by the communications system 100. As depicted in FIG. 2, in some particular examples, the fourth node 114 may be an AF or an AS running a 3PP application. In other examples, the fourth node 114 may be an Application Server of a MNO, which may act as the user portal of an MNO. In such examples, the fourth node 114 may run an application of the MNO.

The fifth node 115 may be understood as a node external to the communications system 100 and having a capability to host one or more applications managing delivery of content to a user equipment operating in the communications system 100, such as the UE 130 described below. The second node 112 may interact with the core network of the communications system 100 through the first node 111. In some particular examples, the fifth node 115 may be an AF or an AS of a content provider.

The sixth node 116 be understood as a node that may have a capability to store data grouped into distinct collections of subscription-related information: subscription data, policy data, structured data for exposure, and application data. As depicted in FIG. 2, a non-limiting example of sixth node 116 may be a UDR.

The communications system 100 may also comprise a plurality of user equipments, of which a UE 130 represented in the non-limiting example of FIG. 2. The UE 130 may be also known as e.g., device, a wireless device, mobile terminal, wireless terminal and/or mobile station, mobile telephone, cellular telephone, or laptop with wireless capability, an Internet of Things (IoT) device, or a Customer Premises Equipment (CPE), just to mention some further examples. The UE 130 in the present context may be, for example, portable, pocket-storable, hand-held, computer-comprised, or a vehicle-mounted mobile device, enabled to communicate voice and/or data, via a Radio Access Network (RAN), with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The UE 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 2b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the third node 113 over a second link 152, e.g., a radio link or a wired link. The first node 111 may communicate with the fourth node 114 over a third link 153, e.g., a radio link or a wired link. The first node 111 may communicate with the UE 130, e.g., indirectly, over a fourth link 154, e.g., a radio link or a wired link. The third node 115 may communicate with the UE 130, e.g., indirectly, over a fifth link 155, e.g., a radio link or a wired link. The UE 130 may communicate with the fourth node 114 over a sixth link 156, e.g., a radio link or a wired link. The fifth node 115 may communicate with the UE 130 over a seventh link 157, e.g., a radio link or a wired link. The fifth node 115 may communicate with the fourth node 114 over an eighth link 158, e.g., a radio link or a wired link. The first node 111 may communicate with the sixth node 116 over a ninth link 159, e.g., a radio link or a wired link. The fifth link 115 may communicate with the sixth node 116 over a tenth link 160, e.g., a radio link or a wired link. The radio network node 140 may communicate, directly or indirectly with one or more nodes comprised in the communications system 100 such as the first node 111, via an eleventh link 161, e.g., a radio link or a wired link. The radio network node 140 may communicate with the UE 130 over a twelfth link 162, e.g., a radio link.

Any of the first link 151, the second link 152, the third link 153, the fourth link 154, the fifth link 155, the sixth link 156, the seventh link 157, the eighth link 158, the ninth link 159, the tenth link 160, the eleventh link 161 and/or the twelfth link 162 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

In general, the usage of “first”, “second”, “third”, “fourth”, “fifth”, “sixth”, “seventh”, “eighth”, “ninth”, “tenth”, “eleventh” and/or “twelfth” herein may be understood to be an arbitrary way to denote different elements or entities and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

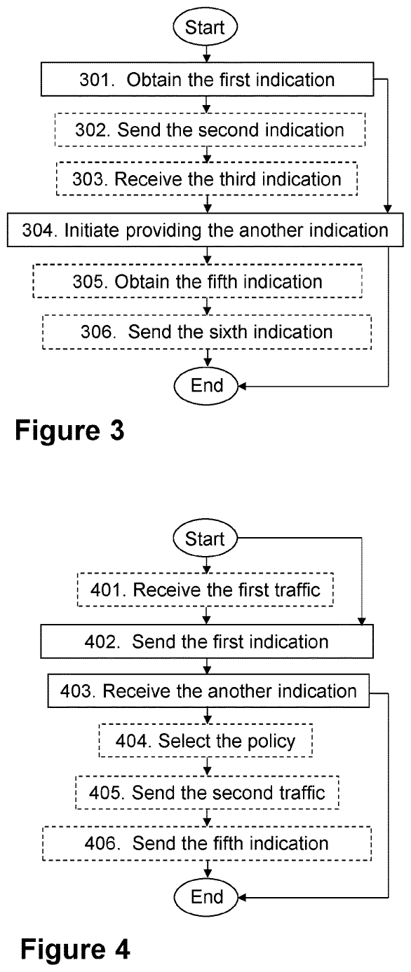

Embodiments of a computer-implemented method, performed by the first node 111, will now be described with reference to the flowchart depicted in FIG. 3. The method may be understood to be for handling information indicating one or more policies. The first node 111 operates in the communications system 100.

In some embodiments, the communications system 100 may be a Fifth Generation, 5G, system.

Several embodiments are comprised herein. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 3.

In FIG. 3, optional actions are represented with dashed lines.

### Action 301

In this Action 301, the first node 111 obtains, directly or indirectly, a first indication from the second node 112. The second node 112 hosts one or more first applications managing delivery of content to the user equipment 130 operating in the communications system 100.

Obtaining may comprise any of retrieving, fetching or receiving. The obtaining, e.g., receiving, may be performed e.g., via the first link 151.

The first indication indicates a request to provide information indicating one or more policies applicable to the content to be delivered to a user of the user equipment 130.

The one or more policies may correspond to quality of service (QOS).

The second node 112 may operate via the communications system 100 and may not have access to the information indicating the one or more policies applicable to the content to be delivered to the user of the user equipment 130. In some embodiments, the second node 112 may be external to the communication system 100. For example, in some embodiments, the second node 112 may be the fifth node 115. The fifth node 115 may be one of a first AF and a first AS of a provider of the content. In other embodiments, the second node 112 may be the user equipment 130. The UE 130 may operate via the communications system 100. In embodiments wherein the second node 112 may be the user of the user equipment 130, the first node 111 may be one of the NEF and a BSS.

Yet in other embodiments, the second node 112 may be the fourth node 114 operating in the communications system 100 and acting on behalf of the user equipment 130. The fourth node 114 may host the one or more second applications. The fourth node 114 may be one of a second AF and a second AS of the communications system 100. In some examples, the fourth node 114 may be an AS/AF running a 3PP application. In other examples, the fourth node 114 may be an AS running an application of the MNO of the communications system 100.

The one or more second applications may be different than the one or more first applications. The one or more second applications, in some examples, may be 3PP applications.

The first node 111 may be one of: a NEF, and a BSS.

In a particular example of embodiments wherein the first node 111 may be a NEF, the first indication may be a new Nnef Application Programming Interface (API)/service Nnef_MNOPolicyExposure (Request/Subscribe), or an extension of the existing Nnef_EventExposure API/service.

In a particular example of embodiments wherein the first node 111 may be a BSS, the first indication may be a Request/Subscribe message.

In some embodiments, the one or more policies may be respectively applicable to at least one of the user of the user equipment 130. and the one or more first applications delivering the content. In some of the embodiments wherein the one or more policies may be respectively applicable to the user of the user equipment 130, the first indication may further indicate a first identifier of the user, or subscriber, of the user equipment 130, e.g., UE-ID.

In some of the embodiments wherein the one or more policies may be respectively applicable to the one or more first applications delivering the content, the first indication may further indicate one or more respective second identifiers of the one or more first applications, e.g., App-ID. In a particular example the one or more respective second identifiers may be provided as a list, e.g., a list of App-ID, e.g., including example. com, which may indicate the list of applications of interest. If no App-ID is included, or is set to “Any”, it may refer to the whole traffic in a user session.

In some embodiments, the first indication may comprise a third identifier, e.g., AF-ID, of the fifth node 115 delivering the content. The fifth node 115 may be accessible via the communications system 100.

In some embodiments, the first indication may optionally further comprise an additional indication to receive updates to the one or more policies. The additional indication may be understood as an indication to subscribe to MNO policy updates. This may be included in case the provider of content may be interested in receiving MNO policy updates for the applications of interest.

In some particular examples, the first indication may comprise the first identifier, the one or more respective second identifiers, the third identifier, and the additional indication, e.g., AF-ID, UE-ID, and list of App-ID including example. com, and optionally, the additional indication to subscribe to MNO policy updates.

In some embodiments, the obtaining in this Action 301 of the first indication may be performed indirectly from the second node 112 via the fourth node 114 operating in the communications system 100. For example, the AS of the MNO, which may act as the user portal of the MNO and communicate with the first node 111 as BSS to provision the information in the request.

By obtaining the first indication in this Action 301, the first node 111 may enable an operator of the communications system 100 to expose the one or more policies that may be allowed for the user equipment 130, through the first node 111, e.g., on a per subscriber basis and/or on a per application basis. The one or more policies may be exposed to the second node 112, e.g., a provider of content or the user of the user equipment 130. This may in turn enable the second node 112, e.g., the AF of a provider of content to request from an MNO, e.g., via a NEF of the communications system 100, the information indicating the one or more policies applicable to the content to be delivered to the user of the user equipment 130. This may enable the second node 112, e.g., the content provider, to choose which may be the most appropriate policy, both on a per subscriber basis, e.g., based on UE-ID, and/or on a per application basis, e.g., based on App-ID. As an example, if the user is has a first type of subscription with the content provider for delivery of high speed data, e.g., 100 Mbps, for traffic of a certain application, and if the user has a second, more basic, type of subscription, e.g., 50 Kbps, with the MNO, the traffic of the application may be handled by the MNO with standard, lower, quality, so the resulting E2E streaming quality will be worse than what the user may be entitled to receive. The most appropriate policy in such an example may be to select the lower speed of delivery of the data, to avoid the application run by the UE 130 from requesting delivery of high speed data and being downgraded to lower speed of delivery, which might cause glitches in the delivery of data, resulting in poor user experience as compared with going directly to lower speed of delivery of data.

In embodiments wherein the second node 112 may be the user equipment 130, the end user of the second node 112 may be enabled to request, e.g., through a 3PP application, the MNO policies for certain application/s, e.g., indicated by a list of App-ID, and to choose which may be the most appropriate policy, both on a per subscriber basis and/or on a per application basis. The request may be conveyed at an application level between the application client and the AS.

### Action 302

After obtaining the first indication, the first node 111 may authorize the request from the second node 112. In this Action 302, the first node 111 may send, based on the obtained first indication, a second indication to the third node 113 operating in the communications system 100. The second indication requests the one or more policies. That is, the first node 111 may forward the request to the third node 113.

The sending in this Action 302 may be performed, e.g., via the second link 152.

The third node 113 may be the PCF. In some particular examples, the first node 111 may be the NEF and the third node 113 may be the PCF.

In some examples, the second indication may be an Npcf_MNOPolicyExposure Request/Subscribe message.

In some examples, the second indication may further indicate the first identifier of the user of the user equipment 130, e.g., UE-ID.

In some examples, the second indication may further indicate the one or more respective second identifiers of the one or more first applications, e.g., App-ID. In a particular example the one or more respective second identifiers may be provided as a list, e.g., a list of App-ID, e.g., including example. com.

In some embodiments, the second indication may further comprise the additional indication to receive updates to the one or more policies.

In some particular examples, the second indication may comprise the first identifier, the one or more respective second identifiers and the additional indication, e.g., UE-ID, list of App-ID, e.g., including example. com, and optionally, the additional indication to subscribe to MNO policy updates.

By the first node 111 sending the second indication to the third node 113 in this Action 302, the first node 111 may be able to retrieve the one or more policies that may be allowed for the user equipment 130, e.g., on a per subscriber basis and/or on a per application basis. The one or more policies may then be exposed to the second node 112.

### Action 303

After receiving the second indication from the first node 111, the third node 113 may look for the currently available MNO policies for the identified user of the user equipment 130, e.g., UE-ID, and identified applications, e.g., App-ID/s and send them to the first node 111. If the additional indication to subscribe to MNO policy updates is present, it may enable the logic to detect and notify relative to policy updates for the identified user, e.g., UE-ID, and applications, e.g., App-ID.

In some embodiments, in this Action 303, the first node 111 may receive a third indication from the third node 113 in response to the sent second indication. The third indication may indicate the requested one or more policies.

The third indication may be, for example, a response. The third indication may, in some examples, comprise the one or more respective second identifiers, which may be provided as a list, e.g., a list of App-ID, as well as the MNO policies.

The receiving in this Action 303 may be performed, e.g., via the second link 152.

By receiving the third indication from the third node 113 in this Action 303, the first node 111 may be enabled to retrieve the one or more policies that may be allowed for the user equipment 130, e.g., on a per subscriber basis and/or on a per application basis. The one or more policies may then be exposed to the second node 112.

### Action 304

In some embodiments, in this Action 304, the first node 111 initiates, responsive to the obtained first indication, providing another indication to the second node 112. The another indication indicates the information.

The another indication may be understood to be a fourth indication.

Initiating may be understood as triggering, starting, facilitating or enabling providing, that is, sending or outputting.

The providing may be performed e.g., via the first link 151.

The another indication may be, for example, a response. The another indication may, in some examples, comprise the one or more respective second identifiers, which may be provided as a list, e.g., a list of App-ID, as well as the MNO policies.

In some embodiments, the one or more policies may be respectively applicable to at least one of the user of the user equipment 130. and the one or more first applications delivering the content. In some of the embodiments wherein the one or more policies may be respectively applicable to the user of the user equipment 130, at least one of the first indication and the another indication may further indicate a first identifier of the user of the user equipment 130. In some of the embodiments wherein the one or more policies may be respectively applicable to the one or more first applications delivering the content, at least one of the first indication and the another indication may further indicate one or more respective second identifiers of the one or more first applications.

By initiating providing the another indication to the second node 112, the first node 111 may forward the available MNO policies for the identified user of the user equipment, e.g., UE-ID, and applications, e.g., App-ID/s, to the second node 112. This may then enable the end user of the user equipment 130 to select the most appropriate policy, e.g., on a per App-ID basis, and indicate it towards the fifth node 115, e.g., the AF/AS of the provider of content, e.g., at application level. Based on this, the fifth node 115, or the second node 112 as AF/AS of the content provider, may then be enabled through the existing Nnef APIs to request the selected policy.

### Action 305

After receiving the another indication from the first node 111, the second node 112 may select a policy, e.g., based on the subscription of the user of the user equipment with the provider of content. The second node 112 may then request the selected policy through the existing APIs, e.g., Nnef APIs.

In accordance with the foregoing, in some embodiments, in this Action 305, the first node 111 may obtain, based on the provided fourth indication, a fifth indication from the second node 112. The fifth indication may request to apply the indicated one or more policies.

The obtaining in this Action 305 may be performed e.g., via the first link 151.

In a particular example, the fifth indication may a Nnef_AFSessionWithQoS and/or Nnef_ChangeChargeableParty (Request).

In some examples wherein the one or more policies may be respectively applicable to the user of the user equipment 130, the fifth indication may further indicate the first identifier of the user of the user equipment 130, e.g., UE-ID.

In some examples wherein the one or more policies may be respectively applicable to the one or more first applications delivering the content, the fifth indication may further indicate the one or more respective second identifiers of the one or more first applications, e.g., App-ID. In a particular example the one or more respective second identifiers may be provided as a list, e.g., a list of App-ID, e.g., including example. com.

In some examples, the fifth indication may comprise the third identifier, e.g., AF-ID, of the fifth node 115 delivering the content. The fifth node 115 may be accessible via the communications system 100.

In some particular examples, the first indication may comprise the first identifier, the one or more respective second identifiers, and the third identifier, e.g., AF-ID, UE-ID, and the list of App-ID including example. com, as well as the requested policy (QOS, Charging).

By obtaining the fifth indication from the second node 112 in this Action 305, the first node 111 may enable the second node 112 to request that the one or more policies that may be allowed for the user equipment 130, e.g., on a per subscriber basis and/or on a per application basis may be applied to traffic for the user equipment 130. This may be understood to in enable that the second node 112 may choose which may be the most appropriate policy, both on a per subscriber basis and/or on a per application basis, for the user equipment 130, so that the user equipment 130 may be appropriately serviced.

### Action 306

Based on the obtained fifth indication, the first node 111 may, in some embodiments, authorize the second node 112, and forward the request comprised in the fifth indication to the third node 113 handling the session for the user equipment 130 identified by the first identifier, e.g., UE-ID. Accordingly, in some embodiments, the first node 111, in this Action 306, may send, based on the obtained fifth indication, a sixth indication to the third node 113. The sixth indication may request to apply the indicated one or more policies to the delivery of the content to the user of the user equipment 130.

The sending in this Action 306 may be performed e.g., via the second link 152.

By sending the fifth indication to the third node 113 in this Action 306, the first node 111 may enable the second node 112 to then deliver application traffic according to the policy selected by the second node 112 and supported by the MNO, e.g., deliver content in Medium Definition (MD)/Low Definition (LD), by generating an Adaptive Bit Rate (ABR) manifest file based on the MNO allowed QoS policies.

Embodiments of a computer-implemented method performed by the second node 112, will now be described with reference to the flowchart depicted in FIG. 4. The method may be understood to be for handling the information indicating the one or more policies. The second node 112 hosts the one or more first applications managing delivery of the content to the user equipment 130 operating in the communications system 100.

The communications system 100 may be a 5G network.

The second node 112 may be one of the following. In some embodiments, the second node 112 may be the fifth node 115 accessible via the communications system 100. The fifth node 115 may be one of the first AF and the first AS of the provider of the content. In other embodiments, the second node 112 may be the user equipment 130. In yet other embodiments, the second node 112 may be the fourth node 114 operating in the communications system 100 and acting on behalf of the user equipment 130. The fourth node 114 may host the one or more second applications.

The fifth node 115 may be one of the first AF, and the first AS of the provider of the content.

The fourth node 114 may be one of the second AF and the second AS of the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some embodiments, the first identifier may be, e.g., a UE-ID.

### Action 401

In some embodiments, in this Action 401, the second node 112 may receive, from the user equipment 130, first traffic corresponding to the one or more first applications.

This Action 401 may be performed in some embodiments wherein the second node 112 may be the fifth node 115. In such embodiments, the receiving in this Action 401 may be performed e.g., via the seventh link 157.

In other embodiments, this Action 401 may be performed in embodiments wherein the second node 112 may be the fourth node 114. In such embodiments, the receiving in this Action 401 may be performed e.g., via the sixth link 156.

### Action 402

In this Action 402, the second node 112 sends, directly or indirectly, the first indication to the first node 111 operating in the communications system 100. The first indication indicates the request to provide the information indicating the one or more policies applicable to the content to be delivered to the user of the user equipment 130.

The one or more policies may be respectively applicable to at least one of the following two options. According to a first option, the one or more policies may be applicable to the user of the user equipment 130. In such embodiments, at least one of the first indication and the another indication may further indicate the first identifier of the user of the user equipment 130. According to a second option, the one or more policies may be respectively applicable to the one or more first applications delivering the content. In such embodiments, at least one of the first indication and the another indication may further indicate the one or more respective second identifiers of the one or more first applications.

The first node 111 may be one of: a) the NEF, and b) the BSS.

The first indication may comprise the third identifier of the fifth node 115 delivering the content. The fifth node 115 may be accessible via the communications system 100.

In some embodiments, the first indication may further comprise the additional indication to receive updates to the one or more policies.

In embodiments wherein Action 401 may have been performed, the first indication may be sent responsive to receiving the first traffic.

In some embodiments, the sending in this Action 402 of the first indication may be performed indirectly from the second node 112 via the fourth node 114 operating in the communications system 100 and acting on behalf of the user equipment 130. The fourth node 114 may host one or more second applications.

The sending in this Action 401 may be performed, e.g., via the first link 151.

### Action 403

In this Action 403, the second node 112 receives, responsive to the sent first indication, the another indication from the first node 111. The another indication indicates the information.

The receiving in this action 403 may be performed, e.g., via the first link 151.

### Action 404

In some embodiments wherein the second node 112 may be the fifth node 115, in this Action 404, that the second node 112 may select, responsive to the received first traffic, a policy out of the one or more policies to be applied to second traffic corresponding to the one or more first applications to the user equipment 130.

### Action 405

In some embodiments wherein the second node 112 may be the fifth node 115, in this Action 405, that the second node 112 may send, responsive to the received first traffic, the second traffic corresponding to the one or more first applications to the user equipment 130, to which second traffic the second node 112 may have applied the selected policy.

The sending in this Action 405 may be performed, e.g., via the seventh link 157.

### Action 406

In some embodiments wherein the another indication may be the fourth indication, in this Action 406, that the second node 112 may send, based on the received fourth indication, the fifth indication to the first node 111. The fifth indication may request to apply the selected policy.

The sending in this action 406 may be performed, e.g., via the first link 151.

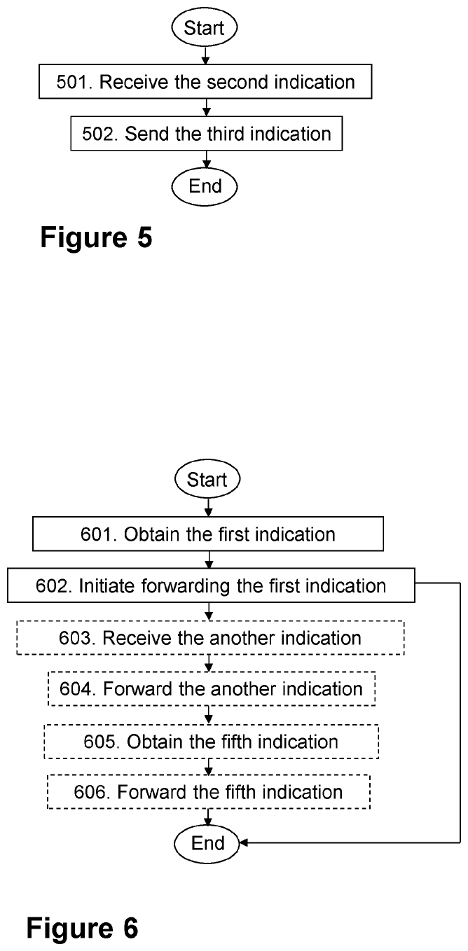

Embodiments of a computer-implemented method performed by the third node 113, will now be described with reference to the flowchart depicted in FIG. 5. The method may be understood to be for handling the information indicating the one or more policies. The third node 113 operates in the communications system 100.

The communications system 100 may be a 5G network.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments, the first identifier may be, e.g., a UE-ID.

### Action 501

In this Action 501, the third node 113 receives, the second indication from the first node 111 operating in the communications system 100. The second indication requests the one or more policies applicable to the content to be delivered to the user of a user equipment 130 operating in the communications system 100.

The receiving of the second indication may be performed e.g., via the second link 152.

The first node 111 may be one of: a) the NEF, and b) the BSS.

The one or more policies may correspond to QoS.

The second indication may correspond to the first indication, forwarded by the first node 111, and originating from the second node 112 hosting the one or more first applications managing delivery of the content to the user equipment 130 operating in the communications system 100.

The second node 112 may be one of the user equipment 130 and the fifth node 115.

The fifth node 115 may be one of the first AF and the first AS of the provider of the content.

The first indication may have been obtained indirectly from the second node 112 via the fourth node 114 operating in the communications system 100 and acting on behalf of the user equipment 130. The fourth node 114 may host the one or more second applications.

The fourth node 114 may be one of the second AF and the second AS of the communications system 100.

In some embodiments, the one or more policies may be respectively applicable to at least one of the user of the user equipment 130 and the one or more first applications delivering the content. In some of the embodiments wherein the one or more policies may be respectively applicable to the user of the user equipment 130, at least one of the second indication and the third indication may further indicate the first identifier of the user equipment 130.

In some of the embodiments wherein the one or more policies may be respectively applicable to the one or more first applications delivering the content, at least one of the second indication and the third indication may further indicate the one or more respective second identifiers of the one or more first applications.

The second indication may comprise the third identifier of the fifth node 115 delivering the content. The fifth node 115 may be accessible via the communications system 100.

The fifth node 115 may be one of the first AF, and the first AS of the provider of the content.

In some embodiments, the second indication may further comprise the additional indication to receive updates to the one or more policies.

### Action 502

The third node 113, in this Action 502, sends the third indication to the first node 111 in response to the received second indication. The third indication indicates the requested one or more policies.

The sending of the third indication may be performed e.g., via the second link 152.

The sending in this Action 502 of the third indication may be performed towards the second node 112, via the first node 111 and then the fourth node 114.

Embodiments of a computer-implemented method performed by the fourth node 114, will now be described with reference to the flowchart depicted in FIG. 6. The method may be understood to be for handling the information indicating the one or more policies. The fourth node 114 operates in the communications system 100 and hosts the one or more second applications. The fourth node 114 may act on behalf of the user equipment 130 operating in the communications system 100.

The fourth node 114 may be one of the second AF and the second AS of the communications system 100. As stated earlier, in some examples, the fourth node 114 may be the AS/AF running a 3PP application. In other examples, the fourth node 114 may be the AS/AF running an application of the MNO.

The communications system 100 may be a 5G network.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, in some embodiments, the first identifier may be, e.g., a UE-ID.

### Action 601

In this Action 601, the fourth node 114 obtains the first indication from the second node 112. The second node 112 hosts the one or more first applications managing delivery of the content to the user equipment 130. The first indication indicates the request to provide the information indicating the one or more policies applicable to the content to be delivered to the user of the user equipment 130.

The second node 112 may be one of the user equipment 130 and the fifth node 115.

The fifth node 115 may be one of the first AF, and the first AS of the provider of the content.

The one or more policies may correspond to QoS.

In some embodiments, the one or more policies may be respectively applicable to at least one of the user of the user equipment 130 and the one or more first applications delivering the content.

In some of the embodiments wherein the one or more policies may be respectively applicable to the user of the user equipment 130, the first indication may further indicate the first identifier of the user equipment 130.

In some of the embodiments wherein the one or more policies may be respectively applicable to the one or more first applications delivering the content, the first indication may further indicate the one or more respective second identifiers of the one or more first applications.

The first indication may comprise the third identifier of the fifth node 115 delivering the content. The fifth node 115 may be accessible via the communications system 100.

In some embodiments, the first indication may further comprise the additional indication to receive updates to the one or more policies.

The obtaining, in this Action 601 may be performed, e.g., via the eighth link 158.

### Action 602

The fourth node 114, in this Action 602, initiates, responsive to the obtained first indication, forwarding the first indication to the first node 111 operating in the communications network 111, thereby initiating providing the another indication to the second node 112. The another indication indicates the information.

The another indication may be the fourth indication

The first node 111 may be one of: a) the NEF, and b) the BSS.

In some of the embodiments wherein the one or more policies may be respectively applicable to the user of the user equipment 130, at least one of the first indication and the another indication may further indicate the first identifier of the user equipment 130.

In some of the embodiments wherein the one or more policies may be respectively applicable to the one or more first applications delivering the content, at least one of the first indication and the another indication may further indicate the one or more respective second identifiers of the one or more first applications.

Initiating may be understood as triggering, starting, facilitating or enabling in this Action 602, forwarding, that is, sending or outputting.

The forwarding in this Action 602 may be performed e.g., via the third link 153.

### Action 603

In some embodiments, the fourth node 114, in this Action 603, may receive, responsive to the forwarded first indication, the another indication from the first node 111. The another indication indicates the information.

The receiving in this Action 603 may be performed e.g., via the third link 153.

### Action 604

In some embodiments, the fourth node 114, in this Action 604, may forward, responsive to the obtained first indication, the received another indication to the second node 112. The another indication indicates the requested one or more policies.

The forwarding in this Action 604 may be performed e.g., via the eighth link 158.

### Action 605

In some embodiments, the fourth node 114, in this Action 605, may obtain, based on the provided fourth indication, the fifth indication from the second node 112. The fifth indication requests to apply the indicated one or more policies.

The obtaining in this Action 605 may be performed, e.g., via the eighth link 158.

### Action 606

In some embodiments, the fourth node 114, in this Action 606, may forward the obtained fifth indication to the first node 111, thereby initiating application of the indicated one or more policies to the delivery of the content to the user of the user equipment 130.

The forwarding in this Action 606 may be performed e.g., via the third link 153.

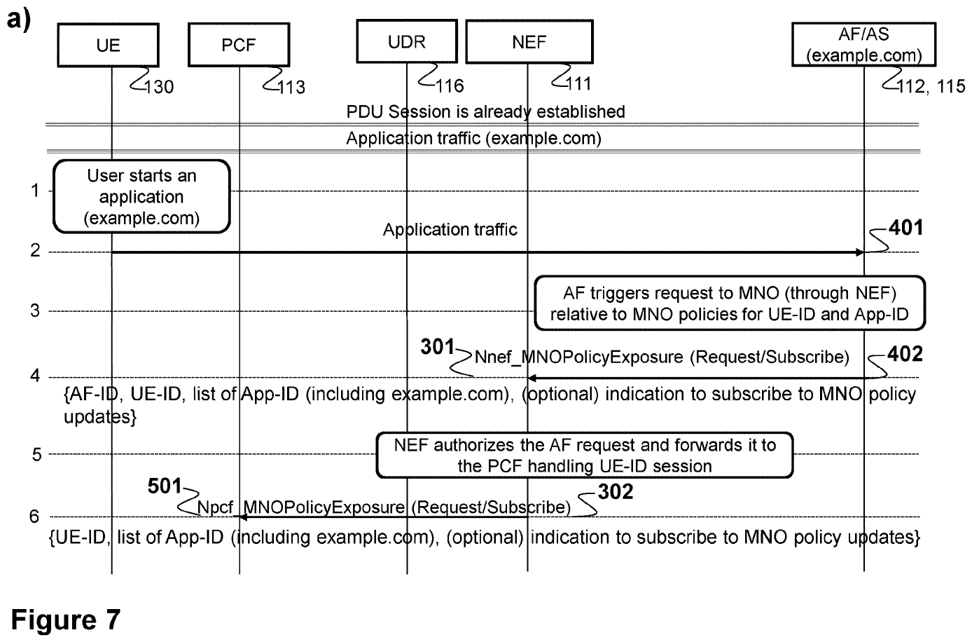

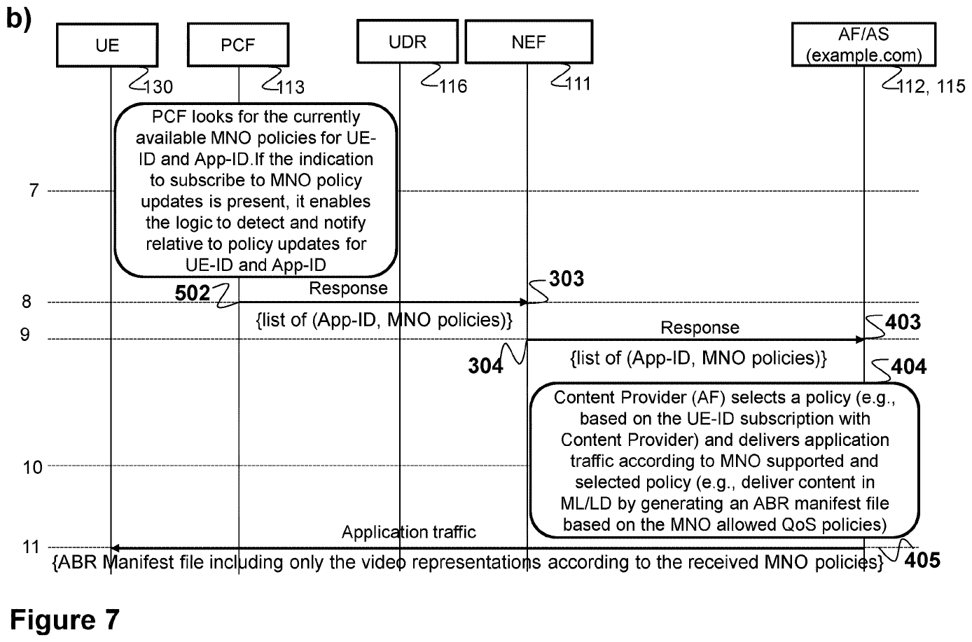

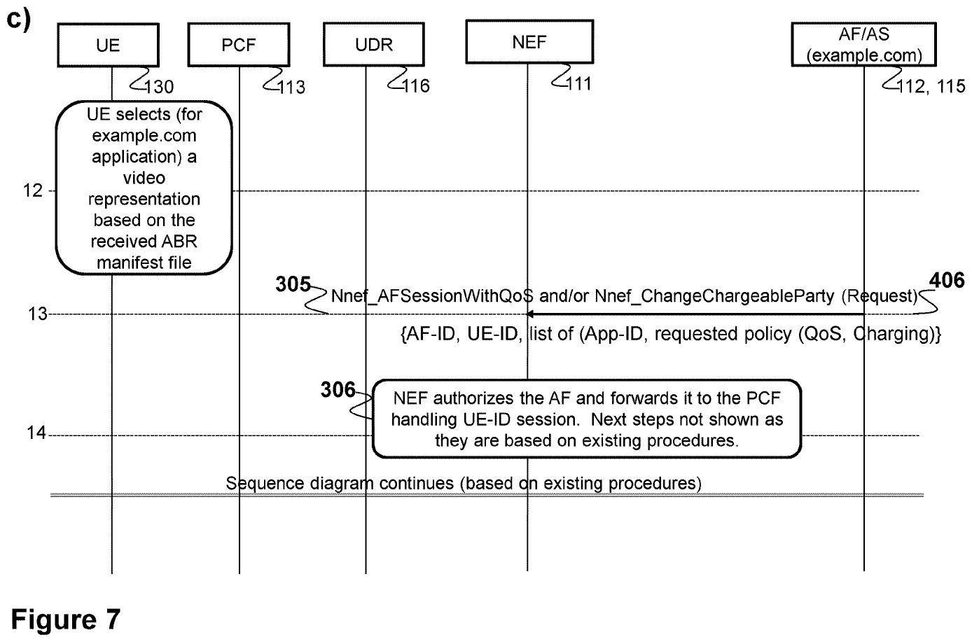

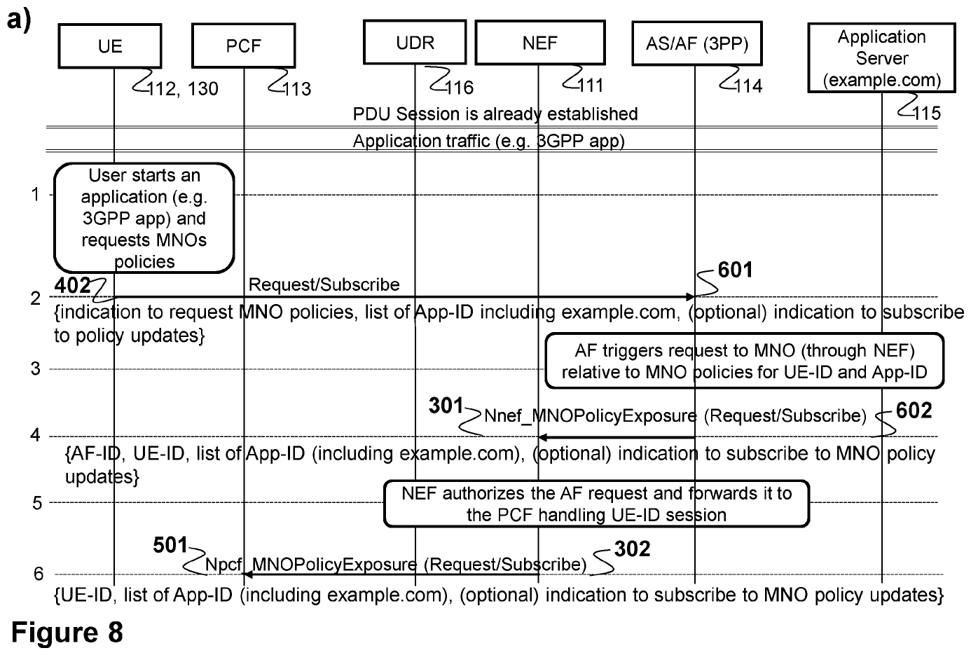

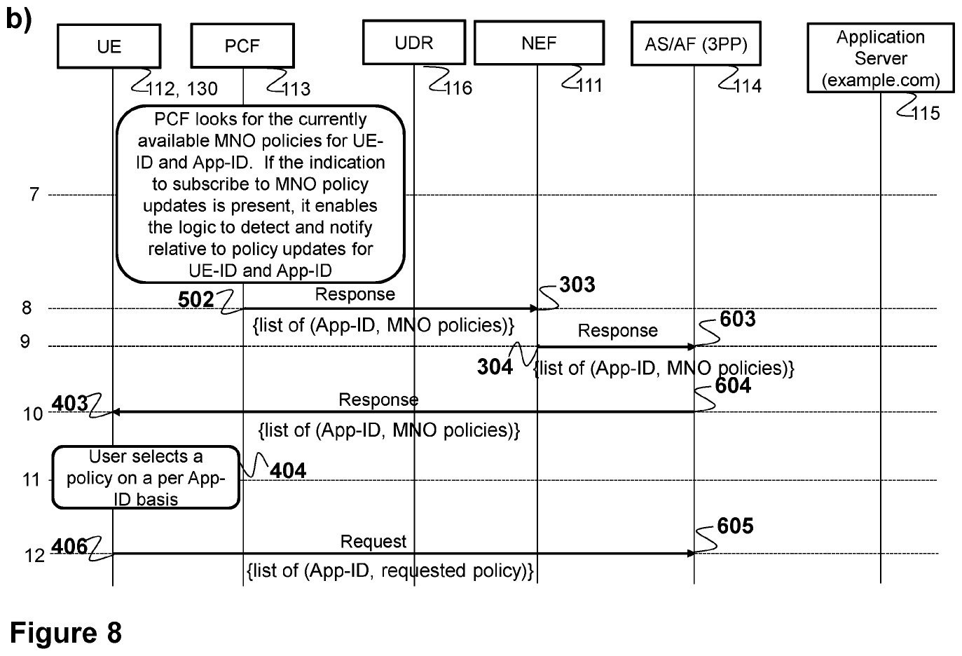

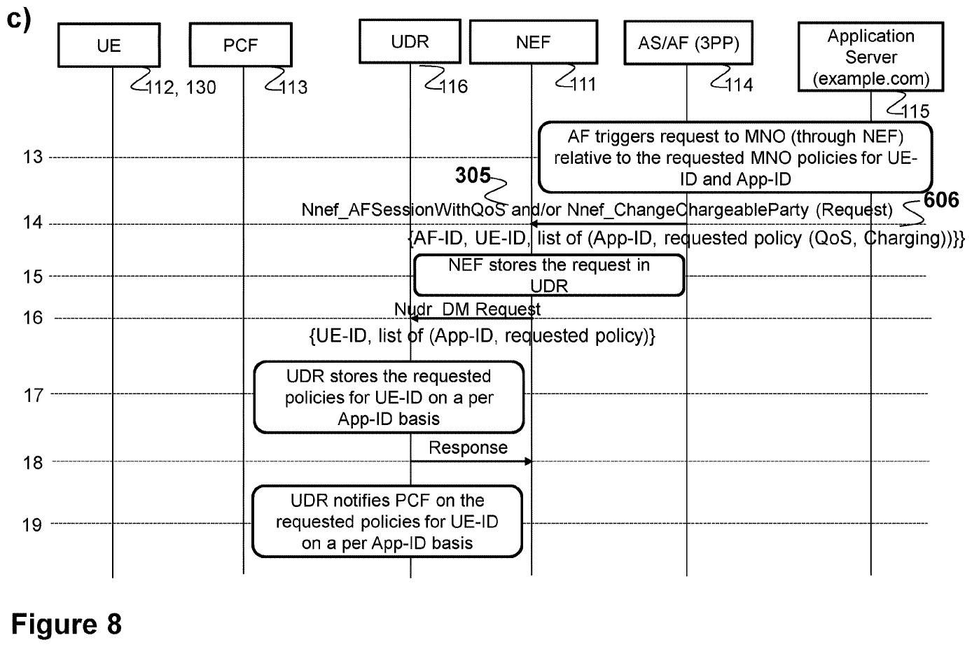

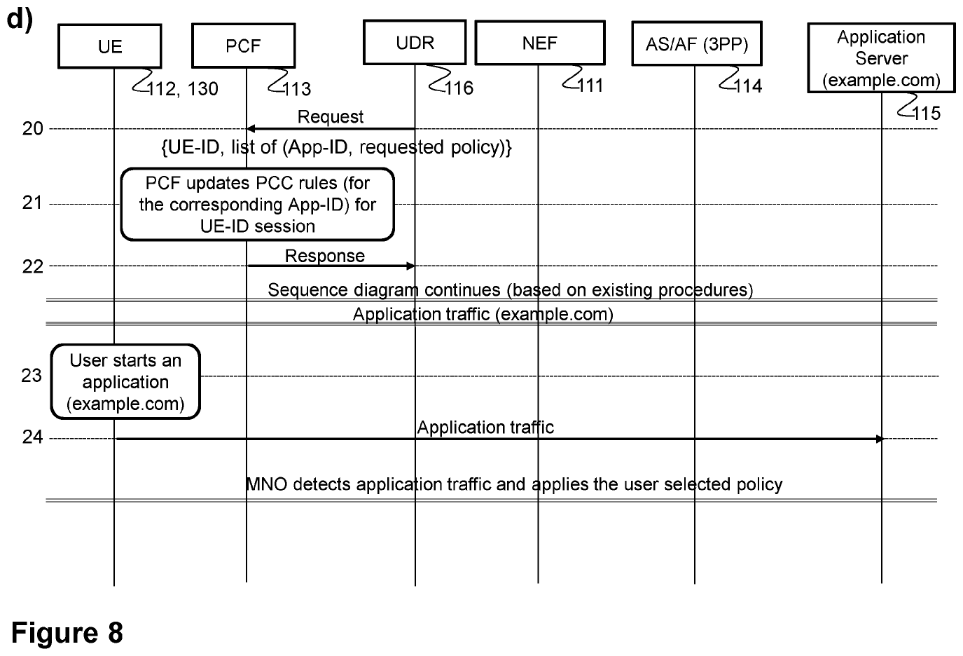

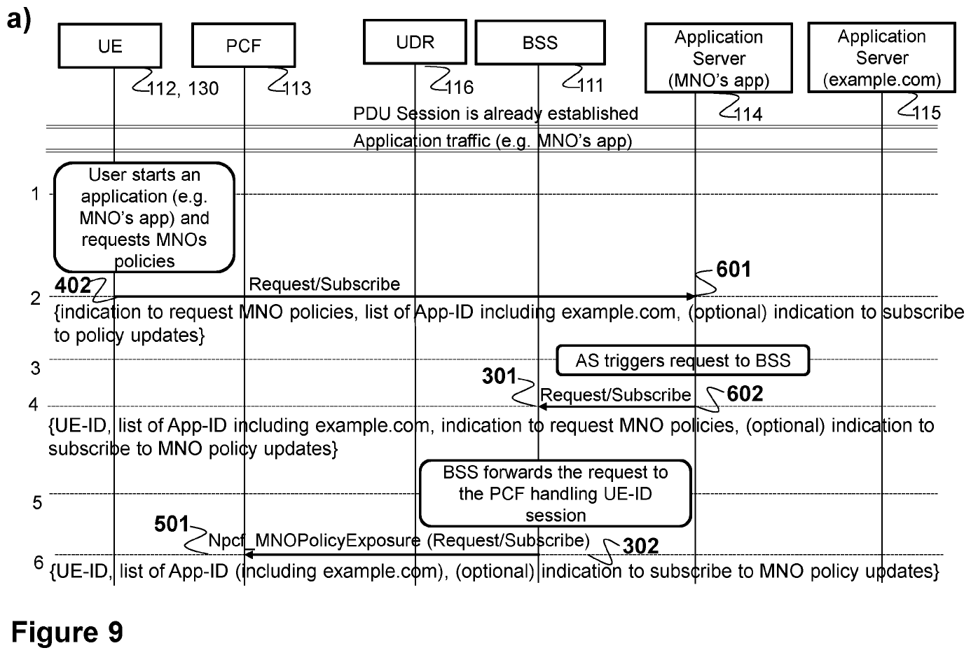

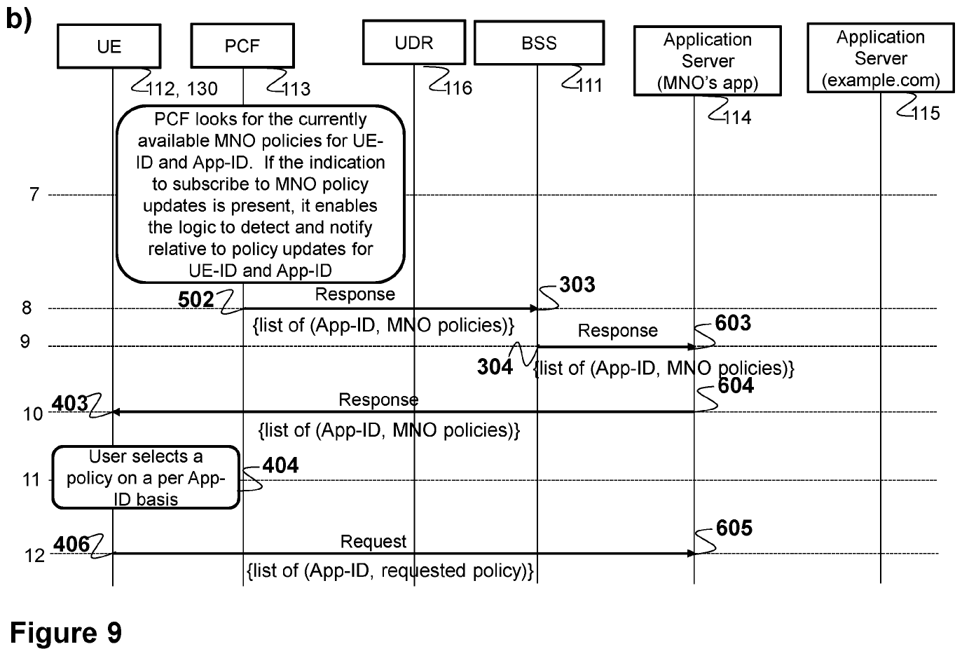

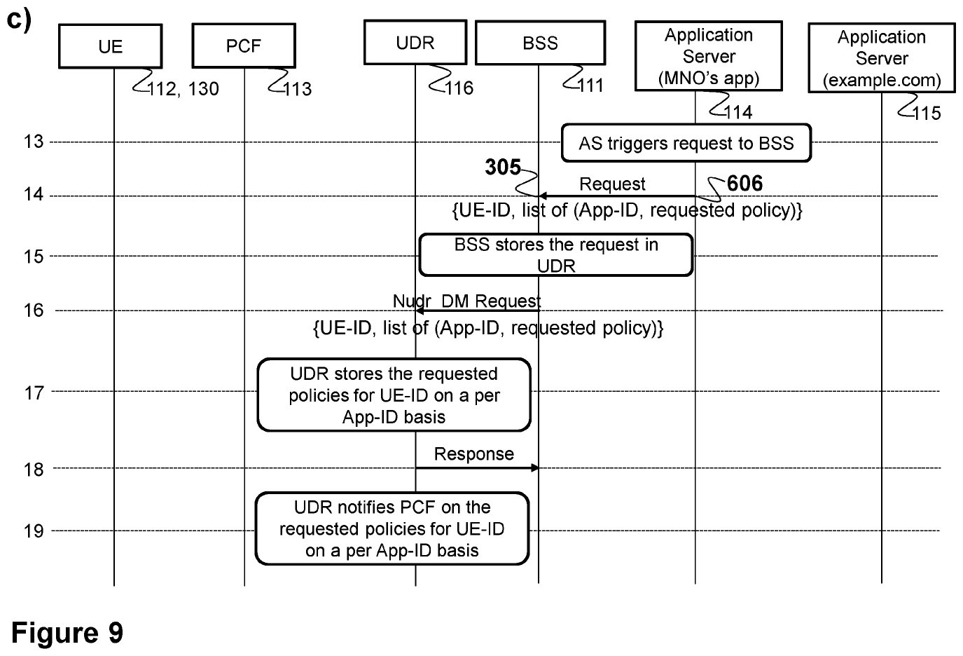

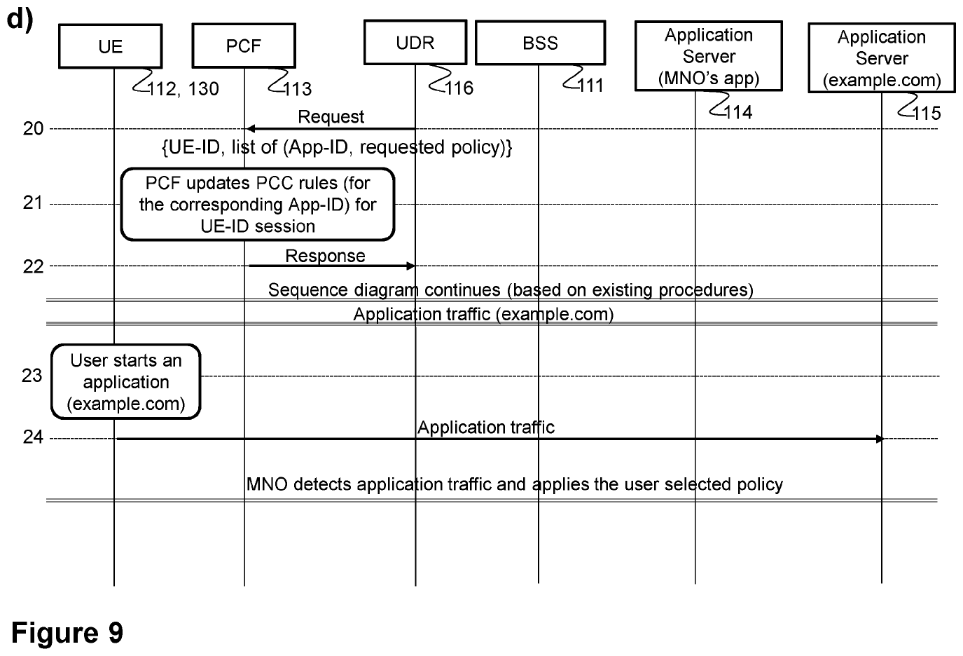

Several non-limiting examples of a method in the communications system 100 according to embodiments herein will now be described in the next FIGS. 7, 8 and 9. Embodiments herein may be understood to support three different use cases. In a first use case, illustrated with a non-limiting example in FIG. 7, MNO policies may be exposed to a provider of content as the second node 112, through the first node 111, wherein the first node 111 is a NEF. In a second use case, illustrated with a non-limiting example in FIG. 8, MNO policies may be exposed to an end user of the user equipment 130 as the second node 112, through the first node 111, wherein the first node 111 is a NEF. In a third use case, illustrated with a non-limiting example in FIG. 9, MNO policies may be exposed to an end user of the user equipment 130 as the second node 112, through the first node 111, wherein the first node 111 is a BSS. In FIGS. 7-9, the communications system 100 is a 5G network, the user equipment 130 is a UE, the third node 113 is a PCF, the sixth node 116 is a UDR and the fifth node 115 is the AF/AS of a provider of content. In FIGS. 8 and 9, the fourth node 114 is the AS/AF of a 3PP application and an application of the MNO, respectively. It may be understood that, in the following examples, any reference to the NEF in FIG. 7 or FIG. 8 may be understood to equally refer to the first node 111, and any reference to the AF/AS in FIG. 7 may be understood to equally refer to the second node 112. It may be understood that, in the following examples, any reference to the BSS in FIG. 9 may be understood to equally refer to the first node 111, and any reference to the user equipment in FIG. 8 or FIG. 9 may be understood to equally refer to the second node 112. Any reference to the Application Server of the content provider in any of FIG. 8 or 9 may be understood to equally refer to the fifth node 115. Similarly, it may be understood that, in the following examples depicted in FIGS. 7-9, any reference to the PCF may be understood to equally refer to the third node 113, any reference to the AS/AF of the MNO application or a 3PP app, may be understood to equally refer to the fourth node 114, and any reference to the UDR may be understood to equally refer to the sixth node 116.

FIG. 7 shows a sequence diagram describing a first non-limiting example of a method performed in the communications system 100, according to embodiments herein, over panels a), b) and c). The example of FIG. 7 depicts an example of a first group of embodiments, wherein policies of the MNO may be exposed to the second node 112 as provider of the content through the first node 111 as NEF. A precondition of the example of FIG. 7 may be understood to be that a PDU session may be already established. In Step 1, an end user of the UE 130, starts an application, e.g., example. com. In Step 2, according to Action 401, the second node 112, here the AF/AS of the provider of content, receives the first traffic corresponding to the one or more first applications from the user equipment 130. In Steps 3 and 4, when receiving the application traffic, the AF/AS of the provider of the content triggers, in accordance with Action 402, a request to the MNO, through the NEF, relative to the MNO policies for the UE-ID and the App-ID, by sending the first indication as a Nnef_MNOPolicyExposure (Request/Subscribe) message, including the following parameters: a) the third identifier, AF-ID, identifying the provider of content, b) the first identifier, UE-ID, identifying the user/subscriber, c) the second identifier, List of App-IDs, identifying the list of applications of interest, including example. com. As indicated earlier, if no App-ID is included, or is set to Any, it may be understood to refer to the whole traffic in the user session. Optionally, the first indication may further comprise the additional indication to subscribe to MNO policy updates. This may be included in case the provider of the content may be interested in receiving MNO policy updates for the applications of interest. In Steps 5 and 6, in accordance with Action 302 and Action 501, the first node 111 as NEF may authorize the request from the AF and forwards it to the third node 113 as the PCF handling UE-ID session, by triggering the second indication as a Npcf_MNOPolicyExposure (Request/Subscribe) message including the parameters in the previous message described in Step 4. Continuing in panel b), in Step 7, the PCF as third node 113 looks for the currently available MNO policies for UE-ID and App-ID. If the indication to subscribe to MNO policy updates is present, the third node 113 may enable the logic to detect and notify relative to policy updates for UE-ID and App-ID. In Step 8, the PCF as third node 113 may, according to Action 502 and Action 303, answer the message in Step 6 above by sending the third indication as a response including the currently available MNO policies for UE-ID and App-ID/s. In Step 9, according to Action 304 and Action 403, the first node 111 may then answer the message in Step 4 by providing the another indication as a response including the information in Step 8. In Steps 10 and 11, the provider of the content, an AF, may, in accordance with Action 404, select a policy, e.g., based on the UE-ID subscription with the provider of the content, and then, according to Action 405, deliver the second traffic as application traffic according to the policy selected and supported by the MNO, e.g., deliver content in MD/LD by generating an ABR manifest file based on the MNO allowed QoS policies, by generating an ABR Manifest file including only the video representations according to the received MNO policies. Continuing in panel c), in Step 12, the UE 130 selects, for the example. com application, a video representation based on the received ABR manifest file. In Step 13, according to Action 305 and Action 406, the second node 112, here the provider of the content, may then request the selected policy through the existing Nnef APIs, e.g., by triggering the fifth indication as Nnef_AFSessionWithQoS and/or Nnef_ChangeChargeableParty (Request) messages, including the selected policies, e.g., QoS and/or charging, for the corresponding applications. In Step 14, according to Action 306, the first node 111 may then authorize the AF request and forward it as the sixth indication to the third node 113, here the PCF handling UE-ID session. Next steps are not shown as they are based on existing procedures.

FIG. 8 is a sequence diagram describing a second non-limiting example of another method performed in the communications system 100, according to embodiments herein, over panels a), b), c) and d). The use case example of FIG. 8 depicts an example of a second group of embodiments, wherein MNO policies may be exposed to the end user of the UE 130, through the NEF, and the UE 130 may request MNO policies for certain application/s e.g., through a 3PP app run by the fourth node 114. A precondition of the example of FIG. 8 may be understood to be that a PDU session may be already established. In Step 1, an end user of the UE 130, or subscriber, starts a 3GPP application, e.g., example. com. In Step 2, according to Action 402 and Action 601, the end user, as second node 112, requests or subscribes to receive, e.g., through a 3PP app, by sending the first indication, MNO policies for a certain application/s, e.g., in a list of App-ID. This request may be conveyed at application level between the application client and the application server (AS), including the following parameters: a) the indication to request MNO policies, b) the second identifier, List of App-IDs, identifying the list of applications of interest, including example. com, and c) the additional indication to subscribe to policy updates. In Steps 3 and 4, according to Action 301 and Action 602, the fourth node 114, the 3PP AF, triggers a request to the MNO through the first node 111 as NEF, relative to MNO policies for the UE-ID and App-ID, by sending the first indication as a Nnef_MNOPolicyExposure (Request/Subscribe) message, including the following parameters: a) an AF-ID, identifying the provider of content, b) the first identifier, UE-ID, identifying the user/subscriber, c) the second identifier, List of App-IDs, identifying the list of applications of interest. As indicated earlier, if no App-ID is included, or is set to Any, it may be understood to refer to the whole traffic in the user session. Optionally, the first indication may further comprise the additional indication to subscribe to MNO policy updates. This may be included in case the provider of the content may be interested in receiving MNO policy updates for the applications of interest. In Steps 5 and 6, in accordance with Action 302 and Action 501, the first node 111 as NEF may authorize the request from the AF and may forward it to the third node 113 as the PCF handling UE-ID session, by triggering the second indication as a Npcf_MNOPolicyExposure (Request/Subscribe) message including the parameters in the previous message described in Step 4. Continuing in panel b), in Step 7, the PCF as third node 113 looks for the currently available MNO policies for UE-ID and App-ID. If the indication to subscribe to MNO policy updates is present, the third node 113 may enable the logic to detect and notify relative to policy updates for UE-ID and App-ID. In Step 8, the PCF as third node 113 may, according to Action 502 and Action 303, answer the message in Step 6 above by sending the third indication as a response including the currently available MNO policies for UE-ID and App-ID/s. In Step 9, according to Action 304 and Action 603, the first node 111 may then answer the message in Step 4 by providing the another indication as a response including the information in Step 8. In Step 10, the AF of the 3PP application, through the AS, may, in accordance with Action 604 and Action 403, forward, at the application level, the available MNO policies for the UE-ID and App-ID/s to the application client by forwarding the another indication as a response. In Step 11, the end user of the user equipment 130 may, according to Action 404, select the most appropriate policy on a per App-ID basis. In Step 12, the 3PP application client, in accordance with Action 406 and Action 605, may send the selected policy to the AS/AF at the application level in a request as the fifth indication. Continuing in panel c), in Step 13 and 14, according to Action 305 and Action 606, the fourth node 114, the AF, may then request the selected policy through the existing Nnef APIs, e.g., by triggering the fifth indication as Nnef_AFSessionWithQoS and/or Nnef_ChangeChargeableParty (Request) messages, including the selected policies, e.g., QoS and/or charging, for the corresponding applications. In 15 to 17, the first node 111, here the NEF, may then authorize the AF request and store it in UDR by triggering a Nudr_DM Request message including the following parameters: the first identifier, here UE-ID, and the second identifier, List of App-IDs, requested policy. In Steps 17 and 18, the sixth node 116, here the UDR, may store the requested policies for the UE-ID on a per App-ID basis and answer the message in Step 16 indicating successful operation. In Steps 19 and, continuing on panel d), Step 20, the UDR may notify the third node 113, here the PCF, on the requested policies for the UE-ID on a per App-ID basis. In Step 21, the PCF may update PCC rules, for the corresponding App-ID, for UE-ID session. This is not shown in the sequence diagram of FIG. 8 as it is based on existing PCC rule update procedures, towards SMF/UPF. In Step 22, the PCF answers the message from the UDR in Step 20 indicating successful operation. In Steps 23 and 24, the user of the user equipment 130 starts an application, e.g., example. com, and generates traffic. The MNO may then detect application traffic and apply the user selected policy.

FIG. 9 is a sequence diagram describing a third non-limiting example of another method performed in the communications system 100, according to embodiments herein, over panels a), b), c) and d). The use case example of FIG. 9 depicts an example of a third group of embodiments, wherein MNO policies may be exposed to the end user of the UE 130, through a BSS. Not all the steps are described in the following text, as they are the same as in FIG. 8, with the following differences. It is assumed here that the request for the one or more policies is sent by the user of the user equipment 130 via the fourth node 114, which may be in this third group of embodiments, an application of the MNO, instead of an external, and potentially untrusted, third party, e.g., 3PP, application. It may then be the fourth node 114 as Application Server of the MNO which may act as user portal of the MNO and communicate with the first node 111 as BSS, instead of with the NEF.

As a summarized view of the foregoing, embodiments herein may be understood to provide mechanisms which may enable the MNO of the communications system 100 to expose allowed policies through the NEF, or through the BSS, this both on a per subscriber basis and/or on a per application basis.

Certain embodiments disclosed herein may provide one or more of the following technical advantage(s), which may be summarized as follows.

Embodiments herein may be understood to enable a network operator to expose the allowed policies through the NEF or the BSS, this both on a per subscriber basis and/or on a per application basis. This may be understood to in turn allow the end user to choose which may be the most appropriate policy, both on a per subscriber basis and/or on a per application basis. This may also be understood to in turn allow the provider of content to choose which may be the most appropriate policy, both on a per subscriber basis and/or on a per application basis.

Embodiments herein may be understood to not only apply to 5G network architecture, but the same mechanisms can be applied to 4G, just by replacing AF by SCS/AS, NEF by SCEF, PCF by Policy Control Rules Function (PCRF), and UDR by Subscriber Profile Repository (SPR).

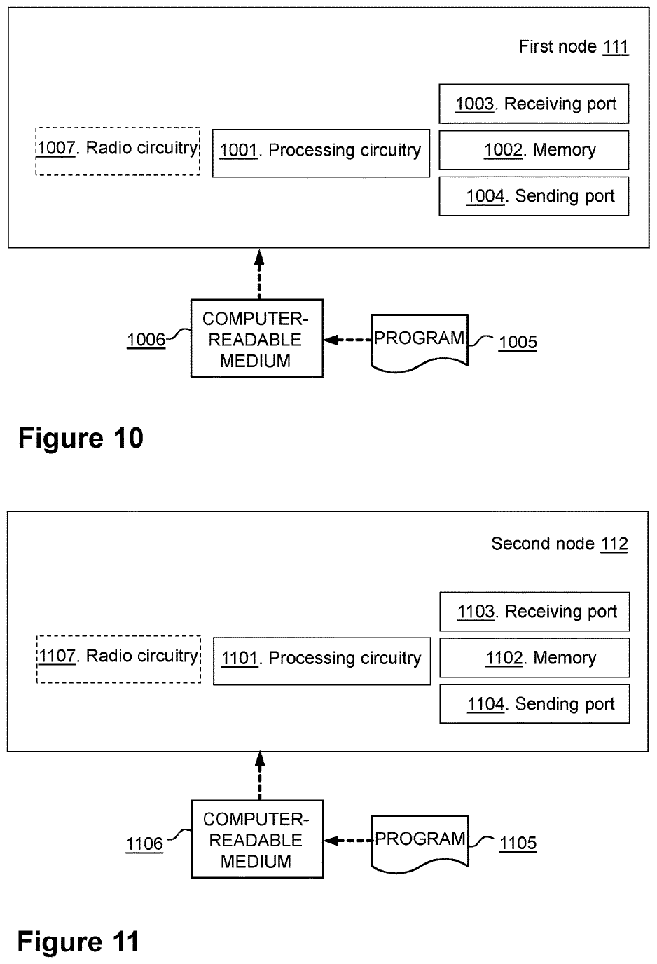

FIG. 10 depicts an example of the arrangement that the first node 111 may comprise to perform the method described in FIG. 3 and/or FIGS. 7-9. The first node 111 may be understood to be for handling the information configured to indicate the one or more policies. The first node 111 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the first identifier may be configured to be, e.g., a UE-ID.

The first node 111 is configured to obtain, directly or indirectly, the first indication from the second node 112. The second node 112 is configured to host the one or more first applications configured to manage the delivery of the content to the user equipment 130 configured to operate in the communications system 100. The first indication is configured to indicate the request to provide the information configured to indicate the one or more policies configured to be applicable to the content configured to be delivered to the user of the user equipment 130.

The first node 111 is also configured to initiate, responsive to the first indication configured to be obtained, providing the another indication to the second node 112. The another indication is configured to indicate the information.

The one or more policies may be configured to be respectively applicable to at least one of: a) the user of the user equipment 130, wherein at least one of the first indication and the another indication may be configured to further indicate the first identifier of the user of the user equipment 130, and b) the one or more first applications configured to deliver the content, wherein at least one of the first indication and the another indication may be configured to further indicate the one or more respective second identifiers of the one or more first applications.

In some embodiments, the first node 111 may be further configured to send, based on the first indication configured to be obtained, the second indication to the third node 113 configured to be operating in the communications system 100. The second indication is configured to request the one or more policies.

In some embodiments, the first node 111 may be further configured to receive the third indication from the third node 113 in response to the sent second indication. The third indication may be configured to indicate the requested one or more policies.

In some embodiments, the another indication may be configured to be the fourth indication and the first node 111 may be further configured to obtain, based on the fourth indication configured to be provided, the fifth indication from the second node 112. The fifth indication may be configured to request to apply the indicated one or more policies.

In some embodiments, the another indication may be configured to be the fourth indication and the first node 111 may be further configured to send, based on the fifth indication configured to be obtained, the sixth indication to the third node 113. The sixth indication may be configured to request to apply the one or more policies configured to be indicated to the delivery of the content to the user of the user equipment 130.

In some embodiments, at least one of the following may apply: a) the first node 111 may be configured to be one of: i) a NEF, and ii) a BSS; b) the one or more policies may be configured to correspond to quality of service, c) the first indication may be configured to comprise the third identifier of the fifth node 115 delivering the content, the fifth node 115 being configured to be accessible via the communications system 100, d) the first indication may be configured to further comprise the additional indication to receive updates to the one or more policies, e) the second node 112 may be configured to one of: the fifth node 115, the user equipment 130, and the fourth node 114 configured to operate in the communications system 100 and act on behalf of the user equipment 130, the fourth node 114 being configured to host the one or more second applications, f) the fifth node 115 may be configured to be one of the first AF, and the first AS of the provider of the content, g) the fourth node 114 may be configured to be one of the second AF and the second AS of the communications system 100, h) the obtaining of the first indication may be configured to be performed indirectly from the second node 112 via the fourth node 114 configured to operate in the communications system 100, and i) the communications system 100 may be configured to be a 5G network.

The embodiments herein in the first node 111 may be implemented through one or more processors, such as a processing circuitry 1001 in the first node 111 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1002 comprising one or more memory units. The memory 1002 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the sixth node 116, the radio network node 140, the UE 130, another node, and/or another structure in the communications system 100, through a receiving port 1003. In some embodiments, the receiving port 1003 may be, for example, connected to one or more antennas in first node 111. In other embodiments, the first node 111 may receive information from another structure in the communications system 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the first node 111 may be further configured to transmit or send information to e.g., the second node 112, the third node 113, the fourth node 114, the fifth node 115, the sixth node 116, the radio network node 140, the UE 130, another node, and/or another structure in the communications system 100, through a sending port 1004, which may be in communication with the processing circuitry 1001, and the memory 1002.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 1001.

Thus, the methods according to the embodiments described herein for the first node 111 may be respectively implemented by means of a computer program 1005 product, comprising instructions, i.e., software code portions, which, when executed on at least one processing circuitry 1001, cause the at least one processing circuitry 1001 to carry out the actions described herein, as performed by the first node 111. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the first node 111. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The first node 111 may comprise a communication interface configured to facilitate, or an interface unit to facilitate, communications between the first node 111 and other nodes or devices, e.g., the second node 112, the third node 113, the fourth node 114, the fifth node 115, the sixth node 116, the radio network node 140, the UE 130, another node, and/or another structure in the communications system 100. The interface may, for example, include a transceiver configured to transmit and receive radio signals over an air interface in accordance with a suitable standard.

In other embodiments, the first node 111 may comprise a radio circuitry 1007, which may comprise e.g., the receiving port 1003 and the sending port 1004.

The radio circuitry 1007 may be configured to set up and maintain at least a wireless connection with the second node 112, the third node 113, the fourth node 114, the fifth node 115, the sixth node 116, the radio network node 140, the UE 130, another node, and/or another structure in the communications system 100. Circuitry may be understood herein as a hardware component.

Hence, embodiments herein also relate to the first node 111 operative to operate in the communications system 100. The first node 111 may comprise the processing circuitry 1001 and the memory 1002, said memory 1002 containing instructions executable by said processing circuitry 1001, whereby the first node 111 is further operative to perform the actions described herein in relation to the first node 111, e.g., in FIG. 3 and/or FIGS. 7-9.

FIG. 11 depicts an example of the arrangement that the second node 112 may comprise to perform the method described in FIG. 4 and/or FIGS. 7-9. The second node 112 may be understood to be for handling the information configured to indicate the one or more policies. The second node 112 is configured to host the one or more first applications configured to manage the delivery of the content to the user equipment 130 configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112 and will thus not be repeated here. For example, the first identifier may be configured to be, e.g., a UE-ID.

The second node 112 is configured to send, directly or indirectly, the first indication to the first node 111 configured to operate in the communications system 100. The first indication is configured to indicate the request to provide the information configured to indicate the one or more policies configured to be applicable to the content to be delivered to the user of the user equipment 130.

The second node 112 is also configured to receive, responsive to the first indication configured to be sent, the another indication from the first node 111. The another indication is configured to indicate the information.

The one or more policies may be configured to be respectively applicable to at least one of: a) the user of the user equipment 130, wherein at least one of the first indication and the another indication may be configured to further indicate the first identifier of the user of the user equipment 130, and b) the one or more first applications configured to deliver the content, wherein at least one of the first indication and the another indication may be configured to further indicate the one or more respective second identifiers of the one or more first applications.

In some embodiments, the second node 112 may be further configured to be one of: a) the fifth node 115 configured to be accessible via the communications system 100, wherein the fifth node 115 may be configured to be one of the first AF and the first AS of the provider of the content, b) the user equipment 130, and c) the fourth node 114 configured to operate in the communications system 100 and act on behalf of the user equipment 130, wherein the fourth node 114 may be configured to host the one or more second applications.

In some embodiments, wherein the second node 112 may be configured to be the fifth node 115, the second node 112 may be further configured to receive, from the user equipment 130, the first traffic configured to correspond to the one or more first applications. The first indication may be configured to be sent responsive to receiving the first traffic.

In some embodiments, wherein the second node 112 may be configured to be the fifth node 115, the second node 112 may be further configured to select, responsive to the received first traffic, the policy out of the one or more policies to be applied to the second traffic configured to correspond to the one or more first applications to the user equipment 130.

In some embodiments, wherein the second node 112 may be configured to be the fifth node 115, the second node 112 may be further configured to send, responsive to the received first traffic, the second traffic configured to correspond to the one or more first applications to the user equipment 130, to which second traffic the second node 112 may be configured to have applied the selected policy.

In some embodiments, the another indication may be configured to be the fourth indication and the second node 112 may be further configured to send, based on the fourth indication configured to be received, the fifth indication to the first node 111. The fifth indication may be configured to request to apply the policy configured to be selected.

In some embodiments, the second node 112 may be configured to be the fourth node 114, and the second node 112 may be further configured to receive, from the user equipment 130, the first traffic configured to correspond to the one or more first applications. The first indication may be configured to be sent responsive to receiving the first traffic.

In some embodiments, at least one of the following may apply: a) the first node 111 may be configured to be one of: i) a NEF, and ii) a BSS; b) the one or more policies may be configured to correspond to quality of service, c) the first indication may be configured to comprise the third identifier of the fifth node 115 delivering the content, the fifth node 115 being configured to be accessible via the communications system 100, d) the fifth node 115 may be configured to be one of the first AF, and the first AS of the provider of the content, e) the first indication may be configured to further comprise the additional indication to receive updates to the one or more policies, f) the sending of the first indication may be configured to be performed indirectly from the second node 112 via the fourth node 114 configured to operate in the communications system 100 and act on behalf of the user equipment 130, wherein the fourth node 114 may be configured to host the one or more second applications, second node (112), g) the fourth node 114 may be configured to be one of the second AF and the second AS of the communications system 100, and h) the communications system 100 may be configured to be a 5G network.

The embodiments herein in the second node 112 may be implemented through one or more processors, such as a processing circuitry 1101 in the second node 112 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1102 comprising one or more memory units. The memory 1102 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the sixth node 116, the radio network node 140, the UE 130, another node, and/or another structure in the communications system 100, through a receiving port 1103. In some embodiments, the receiving port 1103 may be, for example, connected to one or more antennas in second node 112. In other embodiments, the second node 112 may receive information from another structure in the communications system 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the second node 112 may be further configured to transmit or send information to e.g., the first node 111, the third node 113, the fourth node 114, the fifth node 115, the sixth node 116, the radio network node 140, the UE 130, another node, and/or another structure in the communications system 100, through a sending port 1104, which may be in communication with the processing circuitry 1101, and the memory 1102.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1101.

Thus, the methods according to the embodiments described herein for the second node 112 may be respectively implemented by means of a computer program 1105 product, comprising instructions, i.e., software code portions, which, when executed on at least one processing circuitry 1101, cause the at least one processing circuitry 1101 to carry out the actions described herein, as performed by the second node 112. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the second node 112. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The second node 112 may comprise a communication interface configured to facilitate, or an interface unit to facilitate, communications between the second node 112 and other nodes or devices, e.g., the first node 111, the third node 113, the fourth node 114, the fifth node 115, the sixth node 116, the radio network node 140, the UE 130, another node, and/or another structure in the communications system 100. The interface may, for example, include a transceiver configured to transmit and receive radio signals over an air interface in accordance with a suitable standard.

In other embodiments, the second node 112 may comprise a radio circuitry 1107, which may comprise e.g., the receiving port 1103 and the sending port 1104.

The radio circuitry 1107 may be configured to set up and maintain at least a wireless connection with the first node 111, the third node 113, the fourth node 114, the fifth node 115, the sixth node 116, the radio network node 140, the UE 130, another node, and/or another structure in the communications system 100. Circuitry may be understood herein as a hardware component.

Hence, embodiments herein also relate to the second node 112, operative to operate in the communications system 100. The second node 112 may comprise the processing circuitry 1101 and the memory 1102, said memory 1102 containing instructions executable by said processing circuitry 1101, whereby the second node 112 is further operative to perform the actions described herein in relation to the second node 112, e.g., in FIG. 4 and/or FIGS. 7-9.

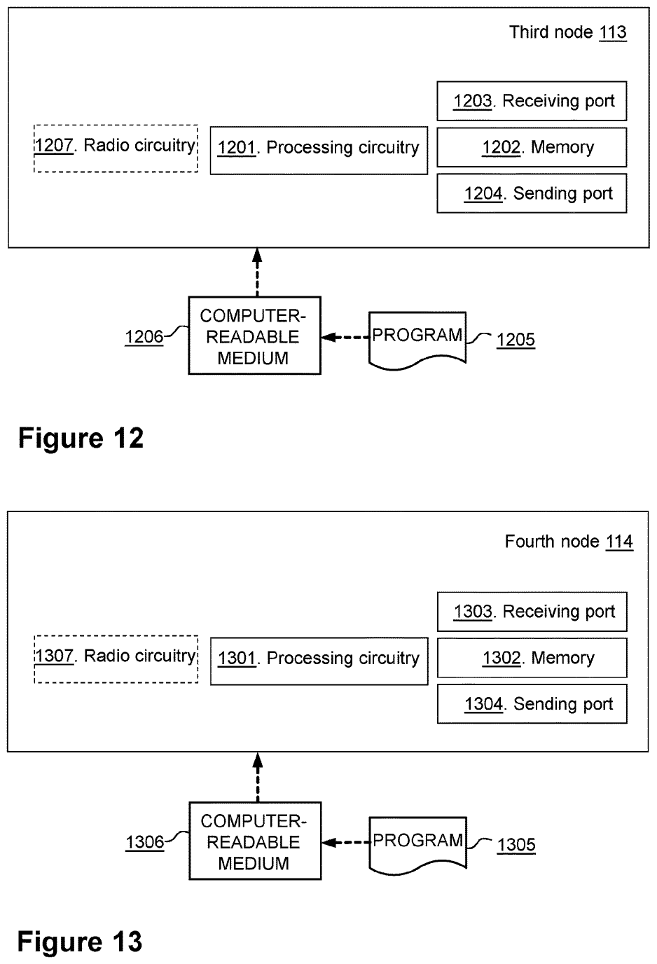

FIG. 12 depicts an example of the arrangement that the third node 113 may comprise to perform the method described in FIG. 5 and/or FIGS. 7-9. The third node 113 may be understood to be for handling the information configured to indicate the one or more policies. The third node 113 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third node 113 and will thus not be repeated here. For example, the first identifier may be configured to be, e.g., a UE-ID.

The third node 113 is configured to receive the second indication from the first node 111 configured to operate in the communications system 100. The second indication is configured to request the one or more policies configured to be applicable to the content to be delivered to the user of the user equipment 130 configured to operate in the communications system 100.

The third node 113 is also configured to send the third indication to the first node 111 in response to the second indication configured to be received. The third indication is configured to indicate the one or more policies configured to be requested.

The one or more policies may be configured to be respectively applicable to at least one of: a) the user of the user equipment 130, wherein at least one of the second indication and the third indication may be configured to further indicate the first identifier of the user of the user equipment 130, and b) the one or more first applications configured to deliver the content, wherein at least one of the second indication and the third indication may be configured to further indicate the one or more respective second identifiers of the one or more first applications.

In some embodiments, at least one of the following may apply: a) the first node 111 may be configured to be one of: i) a NEF, and ii) a BSS; b) the one or more policies may be configured to correspond to quality of service; c) the second indication may be configured to comprise the third identifier of the fifth node 115 delivering the content, the fifth node 115 being configured to be accessible via the communications system 100; d) the second indication may be configured to further comprise the additional indication to receive updates to the one or more policies; e) the fifth node 115 may be configured to be one of the first AF, and the first AS of the provider of the content; f) the second indication may be configured to correspond to the first indication, configured to be forwarded by the first node 111, and configured to originate from the second node 112 configured to host the one or more first applications configured to manage the delivery of the content to the user equipment 130 configured to operate in the communications system 100; g) the second node 112 may be configured to be one of: the user equipment 130 and the fifth node 115; h) the first indication may be configured to have been obtained indirectly from the second node 112 via the fourth node 114 configured to operate in the communications system 100 and act on behalf of the user equipment 130, wherein the fourth node 114 may be configured to host the one or more second applications; i) the fourth node 114 may be configured to be one of the second AF and the second AS of the communications system 100; j) the sending in Action 502 of the third indication may be configured to be performed towards the second node 112, via the first node 111 and then the fourth node 114, and k) the communications system 100 may be configured to be a 5G network.

The embodiments herein in the third node 113 may be implemented through one or more processors, such as a processing circuitry 1201 in the third node 113 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1202 comprising one or more memory units. The memory 1202 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, the fifth node 115, the sixth node 116, the radio network node 140, the UE 130, another node, and/or another structure in the communications system 100, through a receiving port 1203. In some embodiments, the receiving port 1203 may be, for example, connected to one or more antennas in third node 113. In other embodiments, the third node 113 may receive information from another structure in the communications system 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the third node 113 may be further configured to transmit or send information to e.g., the first node 111, the second node 112, the fourth node 114, the fifth node 115, the sixth node 116, the radio network node 140, the UE 130, another node, and/or another structure in the communications system 100, through a sending port 1204, which may be in communication with the processing circuitry 1201, and the memory 1202.

Those skilled in the art will also appreciate that the units comprised within the third node 113 described above as being configured to perform different actions, may refer to a combination of analog and digital circuits, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the third node 113 described above as being configured to perform different actions described above may be implemented as one or more applications running on one or more processors such as the processing circuitry 1201.

Thus, the methods according to the embodiments described herein for the third node 113 may be respectively implemented by means of a computer program 1205 product, comprising instructions, i.e., software code portions, which, when executed on at least one processing circuitry 1201, cause the at least one processing circuitry 1201 to carry out the actions described herein, as performed by the third node 113. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the third node 113. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The third node 113 may comprise a communication interface configured to facilitate, or an interface unit to facilitate, communications between the third node 113 and other nodes or devices, e.g., the first node 111, the second node 112, the fourth node 114, the fifth node 115, the sixth node 116, the radio network node 140, the UE 130, another node, and/or another structure in the communications system 100. The interface may, for example, include a transceiver configured to transmit and receive radio signals over an air interface in accordance with a suitable standard.

In other embodiments, the third node 113 may comprise a radio circuitry 1207, which may comprise e.g., the receiving port 1203 and the sending port 1204.

The radio circuitry 1207 may be configured to set up and maintain at least a wireless connection with the first node 111, the second node 112, the fourth node 114, the fifth node 115, the sixth node 116, the radio network node 140, the UE 130, another node, and/or another structure in the communications system 100. Circuitry may be understood herein as a hardware component.

Hence, embodiments herein also relate to the third node 113, operative to operate in the communications system 100. The third node 113 may comprise the processing circuitry 1201 and the memory 1202, said memory 1202 containing instructions executable by said processing circuitry 1201, whereby the third node 113 is further operative to perform the actions described herein in relation to the third node 113, e.g., in FIG. 5 and/or FIGS. 7-9.

FIG. 13 depicts an example of the arrangement that the fourth node 114 may comprise to perform the method described in FIG. 6 and/or FIGS. 7-9. The fourth node 114 may be understood to be for handling the information configured to indicate the one or more policies. The fourth node 114 is configured to operate in the communications system 100 and host one or more second applications. The fourth node 114 is configured to act on behalf of the user equipment 130 configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the fourth node 114 and will thus not be repeated here. For example, the first identifier may be configured to be, e.g., a UE-ID.

The fourth node 114 is configured to obtain the first indication from the second node 112. The second node 112 is configured to host the one or more first applications configured to manage the delivery of the content to the user equipment 130. The first indication is configured to indicate the request to provide the information configured to indicate the one or more policies configured to be applicable to the content to be delivered to the user of the user equipment 130.

The fourth node 114 is also configured to initiate, responsive to the first indication configured to be obtained, forwarding the first indication to the first node 111 configured to operate in the communications network 111, thereby initiating providing the another indication to the second node 112. The another indication is configured to indicate the information.

The one or more policies may be configured to be respectively applicable to at least one of: a) the user of the user equipment 130, wherein at least one of first indication and the another indication may be configured to further indicate the first identifier of the user of the user equipment 130, and b) the one or more first applications configured to deliver the content, wherein at least one of the first indication and the another indication may be configured to further indicate the one or more respective second identifiers of the one or more first applications.

In some embodiments, the fourth node 114 may also configured to receive, responsive to the forwarded first indication, the another indication from the first node 111. The another indication may be configured to indicate the information.

In some embodiments, the fourth node 114 may also configured to forward, responsive to the first indication configured to be obtained, the another indication configured to be received to the second node 112. The another indication may be configured to indicate the one or more policies configured to be requested.

In some embodiments the another indication may be configured to be the fourth indication and, the fourth node 114 may also configured to obtain, based on the fourth indication configured to be provided, the fifth indication from the second node 112. The fifth indication may be configured to request to apply the one or more policies configured to be indicated.

In some embodiments the another indication may be configured to be the fourth indication and, the fourth node 114 may also configured to forward the fifth indication configured to be obtained to the first node 111, thereby initiating application of the one or more policies configured to be indicated to the delivery of the content to the user of the user equipment 130.

In some embodiments, at least one of the following may apply: a) the first node 111 may be configured to be one of: i) a NEF, and ii) a BSS; b) the one or more policies may be configured to correspond to quality of service; c) the first indication may be configured to comprise the third identifier of the fifth node 115 delivering the content, the fifth node 115 being configured to be accessible via the communications system 100; d) the first indication may be configured to comprise the additional indication to receive updates to the one or more policies; e) the second node 112 may be configured to be one of: the fifth node 115 and the user equipment 130; f) the fifth node 115 may be configured to be one of the first AF, and the first AS of the provider of the content; g) the fourth node 114 may be configured to be one of the second AF and the second AS of the communications system 100; and h) the communications system 100 may be configured to be a 5G network.

The embodiments herein in the fourth node 114 may be implemented through one or more processors, such as a processing circuitry 1301 in the fourth node 114 depicted in FIG. 13, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the fourth node 114. One such carrier may be in the form of a CD ROM disc. It is however feasible with other data carriers such as a memory stick. The computer program code may furthermore be provided as pure program code on a server and downloaded to the fourth node 114.

The fourth node 114 may further comprise a memory 1302 comprising one or more memory units. The memory 1302 is arranged to be used to store obtained information, store data, configurations, schedulings, and applications etc. to perform the methods herein when being executed in the fourth node 114.

In some embodiments, the fourth node 114 may receive information from, e.g., the first node 111, the second node 112, the third node 113, the fifth node 115, the sixth node 116, the radio network node 140, another node, and/or another structure in the communications system 100, through a receiving port 1303. In some embodiments, the receiving port 1303 may be, for example, connected to one or more antennas in fourth node 114. In other embodiments, the fourth node 114 may receive information from another structure in the communications system 100 through the receiving port 1303. Since the receiving port 1303 may be in communication with the processing circuitry 1301, the receiving port 1303 may then send the received information to the processing circuitry 1301. The receiving port 1303 may also be configured to receive other information.

The processing circuitry 1301 in the fourth node 114 may be further configured to transmit or send information to e.g., the first node 111, the second node 112, the third node 113, the fifth node 115, the sixth node 116, the radio network node 140, another node, and/or another structure in the communications system 100, through a sending port 1304, which may be in communication with the processing circuitry 1301, and the memory 1302.

Those skilled in the art will also appreciate that the units comprised within the fourth node 114 described above as being configured to perform different actions, may refer to a combination of analog and digital circuits, and/or one or more processors configured with software and/or firmware, e.g., stored in memory, that, when executed by the one or more processors such as the processing circuitry 1301, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the fourth node 114 described above as being configured to perform different actions described above may be implemented as one or more applications running on one or more processors such as the processing circuitry 1301.

Thus, the methods according to the embodiments described herein for the fourth node 114 may be respectively implemented by means of a computer program 1305 product, comprising instructions, i.e., software code portions, which, when executed on at least one processing circuitry 1301, cause the at least one processing circuitry 1301 to carry out the actions described herein, as performed by the fourth node 114. The computer program 1305 product may be stored on a computer-readable storage medium 1306. The computer-readable storage medium 1306, having stored thereon the computer program 1305, may comprise instructions which, when executed on at least one processing circuitry 1301, cause the at least one processing circuitry 1301 to carry out the actions described herein, as performed by the fourth node 114. In some embodiments, the computer-readable storage medium 1306 may be a non-transitory computer-readable storage medium, such as a CD ROM disc, or a memory stick. In other embodiments, the computer program 1305 product may be stored on a carrier containing the computer program 1305 just described, wherein the carrier is one of an electronic signal, optical signal, radio signal, or the computer-readable storage medium 1306, as described above.

The fourth node 114 may comprise a communication interface configured to facilitate, or an interface unit to facilitate, communications between the fourth node 114 and other nodes or devices, e.g., the first node 111, the second node 112, the third node 113, the fifth node 115, the sixth node 116, the radio network node 140, another node, and/or another structure in the communications system 100. The interface may, for example, include a transceiver configured to transmit and receive radio signals over an air interface in accordance with a suitable standard.

In other embodiments, the fourth node 114 may comprise a radio circuitry 1307, which may comprise e.g., the receiving port 1303 and the sending port 1304.

The radio circuitry 1307 may be configured to set up and maintain at least a wireless connection with the first node 111, the second node 112, the third node 113, the fifth node 115, the sixth node 116, the radio network node 140, another node, and/or another structure in the communications system 100. Circuitry may be understood herein as a hardware component.

Hence, embodiments herein also relate to the fourth node 114, operative to operate in the communications system 100. The fourth node 114 may comprise the processing circuitry 1301 and the memory 1302, said memory 1302 containing instructions executable by said processing circuitry 1301, whereby the fourth node 114 is further operative to perform the actions described herein in relation to the fourth node 114, e.g., in FIG. 6 and/or FIGS. 7-9. Embodiments herein may also comprise the communications system 100 comprising the first node 111 configured as described in relation to FIG. 10, the second node 112 as described in relation to FIG. 11, the third node 113 as described in relation to FIG. 12, and the fourth node 114 as described in relation to FIG. 13.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 29.522 v 17.5.0 (March 2022): 5G System; Network Exposure Function Northbound APIs; Stage 3.

1-41. (canceled)

42. A method, performed by a first node, for handling information indicating one or more policies, the first node operating in a communications system, the method comprising:
obtaining, directly or indirectly, a first indication from a second node, wherein the second node hosts one or more first applications managing delivery of content to a user equipment operating in the communications system, and wherein the first indication indicates a request to provide information indicating one or more policies applicable to the content to be delivered to a user of the user equipment, and
initiating, responsive to the obtained first indication, providing another indication to the second node, the another indication indicating the information.
wherein the one or more policies are respectively applicable to at least one of:
the user of the user equipment, and wherein at least one of the first indication and the another indication further indicate a first identifier of the user of the user equipment, and
the one or more first applications delivering the content, and wherein at least one of the first indication and the another indication further indicate one or more respective second identifiers of the one or more first applications.

43. The method of claim 42, further comprising:
sending, based on the obtained first indication, a second indication to a third node operating in the communications system, the second indication requesting the one or more policies, and
receiving a third indication from the third node in response to the sent second indication, the third indication indicating the requested one or more policies.

44. The method of claim 42, wherein the another indication is a fourth indication and wherein the method further comprises:
obtaining, based on the provided fourth indication, a fifth indication from the second node, the fifth indication requesting to apply the indicated one or more policies, and
sending, based on the obtained fifth indication, a sixth indication to the third node, the sixth indication requesting to apply the indicated one or more policies to the delivery of the content to the user of the user equipment.

45. The method of claim 42, wherein at least one of:
a. the first node is one of: a) a Network Exposure Function (NEF) and b) a Business Support System (BSS),
b. the one or more policies correspond to quality of service,
c. the first indication comprises a third identifier of a fifth node delivering the content, the fifth node being accessible via the communications system,
d. the first indication further comprises an additional indication to receive updates to the one or more policies,
e. the second node is one of: the fifth node, the user equipment, and a fourth node operating in the communications system and acting on behalf of the user equipment, the fourth node hosting one or more second applications,
f. the fifth node is one of a first Application Function (AF) and a first Application Server (AS) of a provider of the content,
g. the fourth node is one of a second AF and a second AS of the communications system,
h. the obtaining of the first indication is performed indirectly from the second node via the fourth node operating in the communications system, and
i. the communications system is a Fifth Generation (5G) network.

46. A method, performed by a second node, for handling information indicating one or more policies, the second node hosting one or more first applications managing delivery of content to a user equipment operating in a communications system, the method comprising:
sending, directly or indirectly, a first indication to a first node operating in the communications system, the first indication indicating a request to provide information indicating one or more policies applicable to the content to be delivered to a user of the user equipment, and
receiving, responsive to the sent first indication, another indication from the first node, the another indication indicating the information,
wherein the one or more policies are respectively applicable to at least one of:
a. the user of the user equipment, and wherein at least one of the first indication and the another indication further indicate a first identifier of the user of the user equipment, and
b. the one or more first applications delivering the content, and wherein at least one of the first indication and the another indication further indicate one or more respective second identifiers of the one or more first applications.

47. The method of claim 46, wherein the second node is one of:
a. a fifth node accessible via the communications system, wherein the fifth node is one of a first Application Function (AF) and a first Application Server (AS) of a provider of the content,
b. the user equipment, and
c. a fourth node operating in the communications system and acting on behalf of the user equipment, wherein the fourth node hosts one or more second applications.

48. The method of claim 47, wherein the second node is the fifth node, and wherein the method further comprises:
receiving, from the user equipment, first traffic corresponding to the one or more first applications, and wherein the first indication is sent responsive to receiving the first traffic,
selecting, responsive to received first traffic, a policy out of the one or more policies to be applied to second traffic corresponding to the one or more first applications to the user equipment, and
sending, responsive to received first traffic, second traffic corresponding to the one or more first applications to the user equipment, to which second traffic the second node has applied the selected policy.

49. The method of claim 48, wherein the another indication is a fourth indication and wherein the method further comprises:
sending, based on the received fourth indication, a fifth indication to the first node, the fifth indication requesting to apply the selected policy.

50. The method of claim 47, wherein the second node is the fourth node, and wherein the method further comprises:
receiving, from the user equipment, first traffic corresponding to the one or more first applications, and wherein the first indication is sent responsive to receiving the first traffic.

51. The method of claim 46, wherein at least one of:
a. the first node is one of: a) a Network Exposure Function (NEF) and b) a Business Support System (BSS),
b. the one or more policies correspond to quality of service,
c. the first indication comprises a third identifier of a fifth node delivering the content, the fifth node being accessible via the communications system,
d. the fifth node is one of a first Application Function (AF) and a first Application Server (AS) of a provider of the content,
e. the first indication further comprises an additional indication to receive updates to the one or more policies,
f. the sending of the first indication is performed indirectly from the second node via a fourth node operating in the communications system and acting on behalf of the user equipment, wherein the fourth node hosts one or more second applications.
g. the fourth node is one of a second AF and a second AS of the communications system, and
h. the communications system is a Fifth Generation (5G) network.

52. A method, performed by a third node, for handling information indicating one or more policies, the third node operating in a communications system, the method comprising:
receiving a second indication from a first node operating in the communications system, the second indication requesting one or more policies applicable to the content to be delivered to a user of a user equipment operating in the communications system, and
sending a third indication to the first node in response to the received second indication, the third indication indicating the requested one or more policies,
wherein the one or more policies are respectively applicable to at least one of:
the user of the user equipment, and wherein at least one of the second indication and the third indication further indicate a first identifier of the user of the user equipment, and
the one or more first applications delivering the content, and wherein at least one of the second indication and the third indication further indicate one or more respective second identifiers of the one or more first applications.

53. The method of claim 52, wherein at least one of:
a. the first node is one of: a) a Network Exposure Function (NEF) and b) a Business Support System (BSS),
b. the one or more policies correspond to quality of service,
c. the second indication comprises a third identifier of a fifth node delivering the content, the fifth node being accessible via the communications system,
d. the second indication further comprises an additional indication to receive updates to the one or more policies,
e. the fifth node is one of a first Application Function (AF) and a first Application Server (AS) of a provider of the content,
f. the second indication corresponds to a first indication, forwarded by the first node, and originating from a second node hosting one or more first applications managing delivery of the content to the user equipment operating in the communications system,
g. the second node is one of: the user equipment and the fifth node,
h. the first indication has been obtained indirectly from the second node via a fourth node operating in the communications system and acting on behalf of the user equipment, wherein the fourth node hosts one or more second applications,
i. the fourth node is one of a second AF and a second AS of the communications system,
j. the sending of the third indication is performed towards the second node, via the first node and then the fourth node, and
k. the communications system is a Fifth Generation (5G) network.

54. A first node, for handling information configured to indicate one or more policies, the first node being configured to operate in a communications system, the first node being further configured to:
obtain, directly or indirectly, a first indication from a second node, wherein the second node is configured to host one or more first applications configured to manage delivery of content to a user equipment configured to operate in the communications system, and wherein the first indication is configured to indicate a request to provide information configured to indicate one or more policies configured to be applicable to the content configured to be delivered to a user of the user equipment, and
initiate, responsive to the first indication configured to be obtained, providing another indication to the second node, the another indication being configured to indicate the information,
wherein the one or more policies are configured to be respectively applicable to at least one of:
a. the user of the user equipment, and wherein at least one of the first indication and the another indication are configured to further indicate a first identifier of the user of the user equipment, and
b. the one or more first applications configured to deliver the content, and wherein at least one of the first indication and the another indication are configured to further indicate one or more respective second identifiers of the one or more first applications.

55. The first node of claim 54, being further configured to:
send, based on the first indication configured to be obtained, a second indication to a third node configured to be operating in the communications system, the second indication being configured to request the one or more policies, and
receive a third indication from the third node in response to the sent second indication, the third indication being configured to indicate the requested one or more policies.

56. The first node of claim 54, wherein the another indication is configured to be a fourth indication and wherein the first node is further configured to:
obtain, based on the fourth indication configured to be provided, a fifth indication from the second node, the fifth indication being configured to request to apply the indicated one or more policies, and
send, based on the fifth indication configured to be obtained, a sixth indication to the third node, the sixth indication being configured to request to apply the one or more policies configured to be indicated to the delivery of the content to the user of the user equipment.

57. The first node of claim 54, wherein at least one of:
a. the first node is configured to be one of: a) a Network Exposure Function (NEF) and b) a Business Support System (BSS),
b. the one or more policies are configured to correspond to quality of service,
c. the first indication is configured to comprises a third identifier of a fifth node delivering the content, the fifth node being configured to be accessible via the communications system,
d. the first indication is configured to further comprise an additional indication to receive updates to the one or more policies,
e. the second node is configured to one of: the fifth node, the user equipment, and a fourth node configured to operate in the communications system and act on behalf of the user equipment, the fourth node being configured to host one or more second applications,
f. the fifth node is configured to be one of a first Application Function (AF) and a first Application Server (AS) of a provider of the content,
g. the fourth node is configured to be one of a second AF and a second AS of the communications system,
h. the obtaining of the first indication is configured to be performed indirectly from the second node via the fourth node configured to operate in the communications system, and
i. the communications system is configured to be a Fifth Generation (5G) network.
